(19) United States
(12) Patent Application Publication
(10) Pub. No.: US 2024/0391093 A1
(43) Pub. Date: Nov. 28, 2024

(54) SYSTEM FOR CONTROLLING AND COORDINATING A GROUP OF DEVICES

(71) Applicant: Miguel Angel MURA YAÑEZ, Santiago (CL)

(72) Inventor: Miguel Angel MURA YAÑEZ, Santiago (CL)

(21) Appl. No.: 18/694,092

(22) PCT Filed: Nov. 20, 2022
(86) PCT No.: PCT/CL2022/050117

§ 371 Date: Mar. 21, 2024

(30) Foreign Application Priority Data
Sep. 22, 2021 (CL) 2458-2021

(51) Int. Cl. B25J 9/16

(52) U.S. Cl. CPC B25J 9/1602; B25J 9/1689; B25J 9/1697

(57) ABSTRACT

The present disclosure relates to a system (1000) to carry out a multiplicity of possible tasks on construction sites and to act in: air, land, sea and under water; safely, increasing execution duration, allowing precision and stability. The system (1000) includes a control unit (100, 101 and 102) to operate vehicles and equipment, for: operation, feeding, transportation and storage; such as: vehicles to transport other vehicles, charge wired, easy contact or wireless power to other vehicles, distribute and manipulate cables with sensors, select, contain and transport objects, units to assemble, store, power, maintain and deliver in the construction sites. The system (1000) includes an UPV Portal-type multi-task autonomous unmanned vehicle, which includes a modular portal-type structure (1.1), extensible motorized legs, to adapt to the inclinations of the terrain and overcome obstacles, where it moves at least one robot arm (1.2) that includes a stabilization base (50) that performs the tasks and another robot arm (1.62) to attach to a construction sites, a centralized mobile reel unit (700A and 700B) which feeds cables and hoses to supply energy, charge power and feed or extract objects, additive and subtractive fluids (e.g. paint, air suction, extraction of a sample, etc.) to the robot arm (1.2) with tools to execute one or multiple possible tasks on a construction site; which includes an end effector, surface cleaner (32) that comprises means for dissolving and extracting dirt without spilling excess.

The present disclosure also relates methods for vehicles and equipment in different environments: operation, layout, transfer, installation, assembly, recharging of fluids and power, and immersion.

### CROSS-REFERENCE TO RELATED APPLICATIONS

This application is a National Stage of International Application No. PCT/CL2022/050117, filed on Nov. 20, 2022, which claims the benefit of an earlier filing date and right of priority to Chile Application No. 2458-2021, filed on Sep. 22, 2021, the contents of which are incorporated herein by reference in their entirety.

### DESCRIPTIVE MEMORY

The presently disclosed a system that solves a multiplicity of tasks in: air, land, sea and under water, in a stable, safer, greater continuity and at greater speed, thereby accelerating the construction of a construction site or periodic maintenance in a construction site with a shorter execution time.

Nowadays the trend is to reduce tasks at height, above water and under water, which involve a risk for workers or people at home. The cost of having personnel in remote locations, on a hill or out to sea, in its various stages is also significant: assembly, maintenance, review of construction projects, etc. Tasks such as: applying paint on a structure over the sea, sucking dust and applying pressurized water to a solar panel, harvesting, etc. They involve great skill and complexity of the maneuver, being a challenge for both men and robotic vehicles.

The disclosed system allows tasks that involve several industries to be carried out simultaneously and resolving the various stages of a construction site: drilling and exploration, installation, review and supervision, maintenance and monitoring. The tasks are so diverse, as an illustrative and non-limiting example: agrivoltaic projects that include different scenarios such as: solar panels on hillsides, floating panels and photovoltaic panels aligned to the planting, where both the photovoltaic panels, such as maintaining the supporting structures and at the same time planting and harvesting the agricultural field.

The system solves a multiplicity of tasks on a construction site, through: main, secondary, inspection and support multitasking vehicles, feeding and assembly units, equipment for transfer and device, on: land, in air, on the water surface, and under the sea, which work independently and also in a coordinated manner.

The field of application of the present disclosure therefore belongs to autonomous vehicles UGVs, USVs, UUVs and UAVs, (in order: UGV, which means “unmanned ground vehicle”, USV, which means “autonomous surface vehicle”, UUV, which means “autonomous underwater vehicle” and UAV, which means “unmanned aerial vehicle”).

The system of the present disclosure can be used in the mining industry, construction, aerospace, aquaculture, agriculture, forestry, but especially in the renewable energy industry and specifically in agrivoltaic (or agrovoltaic) operations, floating photovoltaic plants, on slopes and complementary structures under sea.

### BACKGROUND

Currently, the state of the art to carry out installation, assembly, maintenance, review of the construction and subsequently its maintenance, monitoring and inspection, in construction site on land, sea, under the sea and in the air, as well as new scenarios where economic activities coexist, such as This is agrovoltaics, which requires solving several tasks simultaneously, for example, in the maintenance stage, cleaning a solar panel and at the same time harvesting. Autonomous vehicles have a series of difficulties, both in the operation of the various tasks they involve, coordination of maneuvers, limited spaces, stability and precision of maneuvers in relation to the construction site and the environment. For example, in a photovoltaic or solar thermal plant, where the technical corridors have networks of ducts, pipes and connection or distribution cables, where current vehicles have problems moving, hindering the operation of slower solutions. These difficulties affect the execution of the task, accidents, time and high costs. It is desirable to have vehicles that: can be configured to the environments, have maximum range coverage for the tools, overcome obstacles, adapt to the terrain, free the cables and/or hoses that must inevitably be arranged from obstacles, illuminate, monitor the environment in 3D, and feed supply, additive and/or subtractive fluids and load energy power to keep the operation operational continuously.

Currently, there are systems that allow various tasks to be carried out using autonomous robots and tools, both in construction, photovoltaic plants and agricultural fields. In the installation of the supporting structure of solar panels, automatic machines such as the “STX autonomous system for your pile driving machine” are used for the installation of piles. To place panels on the already arranged structures, a truck is used that advances them on rails, while an ABB-type robot arm places them on them from a truck. For cleaning solar panels there are endless solutions, from aerial vehicles to robot caterpillars, “SolarCleano” that is assembled and other solutions that coexist with a line of solar panels, such as “Solar PV Wash Machine”, as well as other cleaning tools. cleaning that adapt to a vehicle with a telescopic arm such as “The Bitimec PV Solar Washing Machine” and “Photovoltaic Automatic Cleaning Z-Mobile Equipment”. For the review and inspection of photovoltaic panels, a series of drones with various vision technologies, etc., are used. To clean floating panels there are also various solutions such as “hyCLEANER® black SOLAR facelift” and “SolarCleano”. For the installation of foundations that anchor the photovoltaic floating islands, manual means and heavy machinery are used. For underwater inspection, various ROV (which means “Remotely Operated Vehicle”) systems are used, as well as Shark Marine Technologies' Barracuda, from pontoons or surface vessels.

The closest prior art is DE102012003690A1 “Mobile Robot”, which describes that; a mobile robot comprising—an omnidirectional mobile carrier vehicle (1) having a plurality of omnidirectional wheels (13) and drives for driving the omnidirectional wheels (13),—a robot arm (2) having a plurality of links arranged one behind the other (3-7) and drives to move the members (3-7), and—a support device (17) that is adapted to the robot arm (2) in relation to the carrier vehicle (1) that is automatically moves in the carrier vehicle (1) to store and a drive associated with the bearing device (17) to move the robotic arm (2) with respect to the carrier vehicle (1).

The patent US20120152877A1 “Robot for solar farms” describes that; We teach how to use robots with various functions and components . . . understanding said robot: an arm; a trunk; wherein said arm is connected to said trunk; and a toolbox; wherein said toolbox is attached to said trunk; said toolbox comprises one or more tools; where said robot moves on one or more sets of rails or tracks, located in said solar park . . . the following tools, tool tips or devices: brush, broom, . . . carries one or more baby robots . . . in which said robot carries one or more tools adapted for curved or parabola panels or surfaces.

The patent DE102012003690A1 is a mobile robot, in a portal type embodiment, however, the tasks are performed on an attack front, on a work plane. While the patent US20120152877A1 solves a series of tasks with robots and baby robots, for the maintenance and repair of solar panels, however, it is restricted to solar panels arranged in a single series. It does not describe how the robot can move freely on its feet (2 or more). These patents are not versatile either in economic activities of tasks or in media (land, on the surface, sea, air and under the sea), nor do they describe how the power cables are arranged, nor induction charging.

Also some of the previous techniques:
US20100224427A1 “Omnidirectional vehicle, driving module and mobile industrial robot.”
KR100556280B1 “Crane Robot System”
US20130011234A1 “Mobile robot for aggressive and corrosive outdoor environments”
KR101968759B1 “A cable robot for agricultural work.”
US20180153103A1 “Machine for automatic harvesting of fruits grown in rows”
RU2703775C1 “Robot-weeder”.
US20170057081A1 “Modular robot assembly kit, swarm of modularized robots and method of task fulfillment using a swarm of modularized robots”

However, nothing in the prior art discloses the features disclosed below in this description.

The technical problem posed is to provide a system to carry out the construction, installation, maintenance, review and monitoring of a construction site on: land, air, sea and undersea, through: vehicles, equipment, equipment, infrastructure and devices in a systematic manner, coordinated and autonomous. Provide a multipurpose vehicle to a construction site in these environments and that is supported by others to be able to meet the complexity and demands of multiple tasks on a construction site. In a non-limiting example, mainly agrovoltaic (or agrivoltaic) farms on land, on water, on rugged and sloping hills, and the complementary infrastructures they involve, such as structures under the sea and high above the sea.

The prior art does not disclose or consider:
a) a portal type vehicle to which you can connect various equipment and devices to solve various tasks on land, sea and under the sea,
b) a vehicle where the front, sides, rear, horizontally at ground level and in height can be used with a rail capable of supporting tools to cover 360° and additionally provide extensions,
c) a vehicle that can be modulated to increase its work coverage and be able to advance in small technical corridors, for example, in sowing and harvesting,
d) a vehicle that allows overcoming obstacles, for example, the different configurations of photovoltaic plants have pipes and ducts above the ground,
e) a vehicle that allows it to be attached to structures of a work or the natural environment,
f) stability in the robot arm, responding to unevenness, inclinations and accelerations of a terrestrial, sea and undersea environment, for example: rough terrain, slopes on hillsides and on floating photovoltaic plants in constant movement,
a) vehicles that deliver or extract continuous supplies of additive and/or subtractive fluids by cable to other vehicles in the system both on land, sea, undersea and also in flight,
b) vehicles that deliver or retrieve supplies from an object dispenser,
c) vehicles that deliver continuous power charging energy through cables to other vehicles in the system, both on land, at sea, under the sea and also in flight,
d) capsules arranged along the supply cables of additive and/or subtractive fluids and load energy, and that deliver information on position, acceleration, temperature, humidity and other parameters, and that said information is processed by software and establish better maneuvers in the operation, both on land, at sea, under the sea and also in flight,
e) wiring reels, hoses or ducts that feed the system vehicles systematically and according to the operation carried out, both on land, at sea, under the sea and also in flight,
f) vehicles that guide, manipulate, push and orient supply cables of additive and/or subtractive fluids and energy, both on land, at sea, under the sea and also in flight,
g) vehicles that make energy charge wireless power to other vehicles in the system, both on land, at sea, under the sea and also in flight,
h) vehicles that adapt to the terrain and that allow objects to be transported with a conveyor belt at different inclinations,
i) vehicles that adapt to the terrain, which allow selecting, containing objects and reading multiple parameters of the objects,
j) a vehicle at sea that, in a stable manner, allows 3D surveying, illuminating, sending beams of light, constantly monitoring multiple parameters in the environment and charging wireless power to other vehicles,
k) a monitoring station on the seabed that allows 3D surveying, illuminating, sending beams of light, constantly monitoring multiple parameters in the environment and charging wireless power to other vehicles,
l) transportable units that assemble and configure, and maintain and clean the vehicles and equipment that will work on a construction site,
m) transportable units of supplies of additive and/or subtractive fluids and load energy that feed the other vehicles,
n) motorized equipment coupled to aerial vehicles that allow hooking, linking and moving other vehicles, whether on a construction site: land, sea or at height.

The presently disclosed solves all the problems mentioned above and has the following advantages:
continuous supply of objects and additive and/or subtractive fluids.
continuous power supply charging power.
thanks to the above, continuous operations are carried out.
by having means of temporary attachment, adjustable supports for the terrain and a stabilization base for the robot arm, more stable maneuvers are carried out, gaining: precision, power and speed.
by having cables with sensors, feeder reels and supported by software, safe and predictable maneuvers are carried out.
by having constant monitoring and supported by software, it allows predicting the progress and behavior of the execution of the work.
the above translates into efficient and fast operations.

There is still a need in the industry for various jobs on land, at altitude, at sea and under water, to perform more stable, complex, precise maneuvers with a high degree of autonomy, equipment that allows several previous tasks to be carried out and tools that can provide a solution, in order to reduce intervention times in the places where the task or work is carried out.

### Objectives of the Invention

The purpose of the present disclosure application refers to a system that allows reducing the execution time of tasks in a construction site, in its entirety, both in; land, height, over the sea and under water, reducing the accident rate of workers in various industries associated with construction or people at home. Construction site such as: real estate or industrial construction, urban furniture, home, aeronautical hangar, shipyard, wind blades at sea, boats, etc. The task, as an illustrative and non-limiting example, such as: installation, maintenance, inspection, review, constant monitoring of system and environmental parameters, repair, cleaning and supervision of construction site in: air, land, on the sea surface and underwater, and mainly, in agrovoltaic farms, photovoltaic panels on hillsides, floating, on canals and highways, and daily agricultural and photovoltaic tasks in an agrovoltaic (or agrivoltaic) farm located on the slope of a rugged hill, on a farm of floating solar panels on a lake, complementary infrastructure that is above sea and under sea, such as structures and foundations. A great advantage is an equipment that solves tasks in the entire life cycle of said farm, a comprehensive and complete service. Having means of fixing to the structures of the construction site allows the turbulence of the environment, on the water and on the bottom, to be minimized. Having a robot-type arm (6 axes of freedom), such as the KUKA robots, together with a stabilization system, which allows performing very complex and precision tasks complemented with a multiplicity of tools that are coupled and/or connected to this, and they manage to efficiently carry out a multiplicity of tasks. A more stable and precise maneuver allows the process of any task to be carried out with less total energy expended; and improve quality, in turn, resulting in a reduction in material and labor costs. A cable supply allows for greater continuity of operation. Freeing said cable from entanglements and overcoming obstacles significantly speeds up operations on a construction site. It is necessary to move and install the equipment in a building in progress or already constructed, to solve a possible task or to settle there to live with said construction site and carry out periodic tasks. It is also necessary to assemble or maintain the equipment that performs the tasks. These characteristics manage to reduce the time in the place where the task is carried out, thereby reducing logistics and operation costs, significant advances are achieved in the productivity of a construction site and an advantage that is direct over a company that provides these services and an advantage for reduce problems in the company or entity where the task is carried out.

To achieve the above, the system includes: vehicles to transport, assemble, supply and maintain others, multi-task vehicles, inspection vehicles, support vehicles, power supply vehicles, load power and supplies, and special tools. Which involves methods for: the operation, disposition, transfer, installation, assembly, charging fluids and energy, and immersion of autonomous vehicles.

A first object of the present disclosure is to provide a system that allows controlling one or all of the equipment and coordinating them in different media and scenarios to solve multiple tasks on a construction site.

A second object of the present disclosure is to provide a modular vehicle that comprises frames to which rails are attached and connected where robot arms travel on the different fronts (front, right and left sides, bottom, top), providing 360° work coverage and with it different possibilities of acting and solving complex tasks. The frame extends and also allows a cantilever extension to be attached and connected to provide robot arms and increase the coverage field. The module can also be lengthened with another module to increase the working span.

A third object of the present disclosure is to provide stabilization means, to the instability and irregularities of the environment, for which a stabilization unit is provided at the base of the robot arms and vehicles with extendable legs that can respond to the terrain, in addition to temporary fixing means for vehicles, with which the system and vehicles gain strength, precision and stability.

A fourth object of the present disclosure is to provide units that deliver and extract supplies of objects and additive and/or subtractive fluids to the functional and operational tools arranged at the end of the robot arm, allowing an endless number of tasks to be solved, such as, for example: cleaning of objects using liquid solution and pressurized air, delivery of objects through ducts, shot blasting of a surface and subsequent painting.

A fifth object of the present disclosure is to provide units that deliver power energy to other vehicles in the system in a wired way, through a magnetic contact, and wirelessly through induction modules.

A sixth object of the present disclosure is to provide vehicles that guide and push the cables of the vehicles that carry out the delivery of supplies and those that carry out the tasks with the robot arms, avoiding cable entanglements with the system's own equipment and with the infrastructure and the environment, allowing safe maneuvers without damaging them.

A seventh object of the present disclosure is to provide cables with capsules to communicate their position and together with software and 3D vision means, establish their position in relation to the task being performed, a construction site and the environment, and with them predict and improve operations.

An eighth object of the present disclosure is to provide vehicles for: selecting, transporting, loading and transferring objects. In a non-limiting example, agricultural objects, allowing to comply with agrivoltaic environments, configuring mobile production lines for sowing and harvesting: taking them, selecting them, accumulating them, transporting them and moving them to containers. As an example, harvesting requires taking from different heights, depending on the type of agricultural product, at one time vegetables at ground level, fruits at height and sprouts on greenhouse shelves in places confined at height.

A ninth object of the present disclosure is to provide vehicles and stations that allow stable 3D scanning, illuminating and pointing specific light beams at a construction site, and charging power.

A tenth object of the present disclosure is to provide transportable units that allow transporting, assembling and delivering vehicles and equipment to the environment and that are going to be used on a construction site, in addition to providing a supply of additive and/or subtractive fluids and energy charging power.

An eleventh object of the present disclosure is to provide means for transporting vehicles, equipment, system units and infrastructure for transportation, landing and takeoff over sea, then the following are provided: takeoff platforms, pontoon-type base supports, and a motorized device that attaches to a vehicle in flight.

A twelfth object of the present disclosure is to provide a photovoltaic panel cleaner, which is connected to the robot arm in a system vehicle, a self-cleaning cleaner and that prevents excess cleaning liquids from escaping and damaging the environment. The dirty roller filaments are shaken by pressurized air ejectors and a channel with a perimeter seal sucks the dirty liquid and takes it to a recirculation tank arranged in one of the vehicles.

### BRIEF DESCRIPTION OF THE DRAWINGS

Other characteristics and advantages of the present disclosure will become apparent from the following description of its preferred embodiment, given solely by way of illustrative and non-limiting example, with reference to the accompanying drawings, in which:

FIG. 1: is a flow chart of how the system (1000) of the following disclosure operates.

FIG. 2: illustrates a front view, where the autonomous UPV (1) cleans the solar panels by suctioning dust and applying an aqueous solution.

FIG. 3: illustrates detail, break view, of cleaner (32) for photovoltaic panels.

FIG. 4: illustrates a side view, where UPV (1) is overcoming an obstacle.

FIG. 5: illustrates a front view, where UPV (1), supported by equipment of: secondary multitasking, review, support, power in solar panel installation. Wireless charging method.

FIG. 6: illustrates a front view, where UPV wiring (1A), supported by equipment: review, support, power in cleaning of solar panels. Wired supply method.

FIG. 7: illustrates a front view, where UPV larger span and wiring (1B), configuration for rough and sloping terrain, supported by solar panel cleaning equipment. Wired method.

FIG. 8: illustrates a front view, where autonomous UPV (1C), configuration for pile installation, supported by loader equipment and pile pressing device.

FIG. 9: illustrates a side view, where UPV with conveyor belt (1D), configuration for sowing and harvesting, supported by equipment: air and ground support and conveyor belt equipment.

FIG. 10: illustrates a side view, where UPV with conveyor belt (1D), configuration for planting and harvesting, entering a confined space at height, supported by equipment: air and ground support and conveyor belt equipment.

FIG. 11: illustrates a front view, where autonomous UPV (1E), configuration for maintenance and cleaning of floating solar panels, supported by airborne equipment.

FIG. 12: illustrates a front view, where UPV larger span and wiring (1F), configuration for maintenance and cleaning of floating solar panels by equipment on water and in air.

FIG. 13: illustrates a front view, where UPV wired (1G), configuration for maintenance and cleaning of floating solar panels, supported by equipment and cleaner, from the sea surface with wired method. Also from the sea surface and on the seabed; maintenance, inspection and monitoring equipment with method of charging, energy, power and feeding of wired additive and/or subtractive fluids.

FIG. 14: illustrates a side view of the USV feeder (14) to aerial cable equipment and underwater equipment charging by induction.

FIG. 15: Illustrates a side view, of UUV wired multitasking (17) executing a task underwater, powered by UUV feeder (28) and managing cables by UUV organizes cables (18).

FIG. 16: illustrates a side view of UUV organizes cables (18), managing cables.

FIG. 17: illustrates a side view of UUV feeder (29), charging by induction to UUV autonomous multitasking (16).

FIG. 18: illustrates a detail, in broken view, of the stabilization base (50) for the robot arm.

FIG. 19: illustrates a side view of USV organizes cables (33) with cable for vehicles over sea.

FIG. 20: illustrates a detail of the monitoring station (19).

FIG. 21: illustrates a side view of the USV self-stabilized buoy (15) doing power charging, undersea induction method to UUV autonomous multitasking (16).

FIG. 22: illustrates a front view, where UPV larger span and wiring (1H), configuration for maintenance and cleaning of solar panels covers channels and highways, supported by equipment and cleaner. Wired method and transportable supply warehouse.

FIG. 23: Illustrates a side view, where underwater autonomous UPV underwater (1J), configured to submerge.

FIG. 24: Illustrates a front view, where underwater autonomous UPV underwater (1J), configured to submerge, attaches to an underwater structure and performs a task with its robot arms.

FIG. 25: illustrates a sectional front view, showing the assembly process of a vehicle in the transportable assembly unit (22) and which is then moved by the UAV transport (21).

FIG. 26: illustrates a sectional side view of the transportable assembly unit over water (30) introducing equipment under water and delivering supplies.

### DETAILED DESCRIPTION

In the following detailed description, various example embodiments of a system (1000) will be described in detail.

The system (1000) to carry out a multiplicity of possible tasks on construction sites, using autonomous unmanned equipment on: land, air, over water and under water, because it includes at least:
A1) a control base (1001) that in communication with a control unit (100, 101 and 102) for the operation of the system (1000) to control in isolation or together, on land, in the air, on the sea surface and under sea, equipment: operation (1014), supplies (1015) and transportation and storage (1016);
A2) an UPVs Portal-type multi-task autonomous unmanned vehicle (1, 1A to 1J), which include a modular portal-type structure (1.1) where equipment and other devices are assembled according to the environment where the task is located (ground, air, on the surface water and under water), at least three portal rail legs (1.5), each including two parallel extendable portal legs (1.5.1), to adapt to the inclinations of the terrain and overcome obstacles, on these portal rail legs (1.5) are They move motorized, horizontal rail (1.10), to provide work coverage to at least one robot arm (1.2), with several degrees of freedom specially configured with functional and operational tools to execute at least one specific assigned and predefined task, of multiple possible tasks on a construction site, and at least one other robot arm (1.62) on a cantilever rail (1.13) to attach to a structure on the construction site and/or the environment, to allow precision and stability;
A3) the UPV (1) which additionally includes at least: a centralized mobile reel unit (700A), reel (1.6.2), a tank of additive and/or subtractive fluids (1.6.3) and a series of batteries (1.6.4);
A4) the UPV (1C) which additionally includes at least: a pile presser (1.14);
A5) the UPV with conveyor belt (1D) which additionally includes at least: a conveyor belt (1.19), a UAV multitasking (10) (UAV, which means “unmanned aerial vehicle”), and a UAV organizes cables (11);
A6) the UPV underwater (1J) which additionally includes at least: a centralized mobile reel unit (700B), a foam flotation module (1.53), a series of propellers (1.54 and 1.55) and a series of batteries (1.56);
A7) an UUV wired multitasking (17) (UUV, which means “autonomous underwater vehicle”), which has at least one robot arm (1.2) to execute at least one task in a construction site and a robot arm (17.3) to attach to a structure of the construction site, to allow precision and stability;
A8) for operation on the ground and in flight, of the system (1000), it comprises at least one UPV (1), where an UAV reviewer (2) in the air and an UGV reviewer (3) on the ground (UGV, which means “unmanned ground vehicle”), are configured to supervise and inspect tasks executed by UPVs (1, 1A, 1B, 1C, 1D and 1H) and an UAVs multitasking (10), to sense and scan the location of said task; where an UGV feeder (8) and the centralized mobile reel unit (700A) are configured to supply or extract fluids through cables, hoses or supply ducts to the effectors of the robot arm (1.2); where an UGVs (4, 5, 12 and 13) and an UAVs multitasking (10) are configured to support the execution of tasks; where an UGV organize cables (9 and 9A) and an UAV organizes cables (11) are configured to keep the cables and hoses suspended in the air, while;
A9) for operation on the sea surface and in flight, of the system (1000), includes at least the UPV (1E), where an USV self-stabilized buoy (15) (USV, which means “autonomous surface vehicle”) on the sea surface and the UAV reviewer (2) in the air, are configured to supervise and inspect tasks executed by UPVs (1E, 1F, 1G and 1H) and UAV multitasking (10), to sense and scan the location of said task; wherein an USV feeder (14) and the centralized mobile reel unit (700B) are configured to supply or extract fluids through cables, hoses or supply ducts to the effectors of the robot arm (1.2); where an USV self-stabilized buoy (15) and UAV multitasking (10) are configured to support the execution of tasks; where an USV organizes cables (33) and UAV organizes cables (11) are configured to keep the cables and hoses suspended in the air, while;
A10) for underwater operation, of the system (1000), it comprises at least the UPV underwater (1J), where the UUV autonomous multitasking (16) is configured to supervise and inspect tasks executed by UPV underwater (1J) and an UUV wired multitasking (17), to sense and scan the location of said task; where the USV feeder (14), an UUV feeder (28) and the centralized mobile reel unit (700B) are configured to supply or extract fluids through cables, hoses or supply ducts to the effectors of the robot arm (1.2); where the USV self-stabilized buoy (15), an UUV wired multitasking (17), an UUV feeder (29) and monitoring station (19), are configured to support the execution of tasks; where an UUV organizes cables (18) is configured to keep cables and hoses free of interference;
A11) where the UGV reviewer (3) comprises at least: a drive system where it extends on a pedestal (3.2) that is adjusted in height by means of a linear actuator (3.3) to which a rotation unit (3.4) is connected. and from this, a unity of vision;
A12) where the UGV loader (5) comprises at least: a driving means where a robot arm (1.2) with an end effector and a guide for the cable from the centralized mobile reel unit (700A) is located, in addition to, a container with means for detecting and containing the load, and means for tilting and rotating said container;
A13) where the UGV wireless feeder (6) comprises at least: location, vision and control means, and an induction battery (1.6.6);
A14) where the UGV feeder (7) comprises at least: location, vision and control means, a tank of additive and/or subtractive fluids (1.6.3), a series of batteries (1.6.4), a charger induction battery (1.6.5) and an easy contact (1.6.9) for additive and/or subtractive fluids;
A15) where the UGV feeder (8) comprises at least: location, vision and control means, a tank of additive and/or subtractive fluids (1.6.3), a series of batteries (1.6.4), a warehouse object dispenser, and a centralized mobile reel unit (700A);
A16) where the UGV organizes cables (9A), it comprises at least: a spider-type motor system, a robot arm (9A.3) at the end of which an articulated cable pusher (9A.5 and 9A.6) is connected and a guides, which open like a handle, through which the system cable (1000) passes, which lifts, moves, pushes, pulls, lets pass and brakes;
A17) where the UGV distributor (12) comprises at least: a container (12.2) with a vibrating base, a robot arm (1.2), extendable legs (12.4), a conveyor belt (12.6), which, by means of linear actuators and rotation units, said conveyor belt is tilted, and said container is tilted and rotated;
A18) where the USV feeder (14), which comprises a pontoon-type vessel (14.1) and because it includes at least: means of location, artificial vision and control, on the surface, a tank of additive and/or subtractive fluids (14.5), a series of batteries (14.8), a centralized mobile reel unit (700B) that has cables, hoses and ducts, and under the pontoon, inside an induction battery charger (14.9);
A19) where the USV self-stabilized buoy (15) that comprises a hull (15.1) where a tower (15.2) is projected and because it includes at least: at the upper end, means of location, artificial vision and control, some spotlights (19.2) high power LED, a laser pointer (not shown), while the hull and the tower are distanced by a sea stabilization base (51) that comprises three actuators (50.1) arranged radially, and where, the clearance that allows bring these closer and further away, around the hull, a multiplicity of sensors (15.3) are projected towards the seabed, and an induction battery charger (15.5) is located under the hull;
A20) where the UUV autonomous multitasking (16) comprises a UUV (16.1) that includes at least: in the front an artificial vision unit (1.8), in the lower part a robot arm (1.2), and at its end, operational and functional tools, an end effector (1.2.1), while in the front and upper part two robot arms (16.3), and each one at its end, a fixation effector (16.4), while inside an induction battery is located above (16.2);
A21) where the UUV organizes cables (18) that comprises a body (17.1) because it includes at least: artificial vision, control and sonar electronics means (not shown) and, in the lower part, a robot arm (1.2), and at its end an end effector (1.2.1) a gripper, which includes a roller and a motorized roller (not shown), which opens in the manner of a gripper, through which the system cable (1000) passes, the that lifts, moves, pushes, pulls, lets pass and brakes;
A22) where the monitoring station (19) because it includes at least: means of location, control and sonar electronics (not shown) and a series of induction battery chargers (not shown), and also means of artificial vision and a high-power LED spotlight (19.2), where each one is connected to a motorized base;
A23) where the UUV feeder (28) comprising a main hull (28.1), because it includes at least: control means, artificial vision and sonar electronics (not shown), a pair of thrusters (28.3), two lower pairs of front and rear wheels (28.7), a series of batteries (28.5), a tank of additive and/or subtractive fluids (28.6), and a centralized mobile reel unit (700B, not shown) that powers the other vehicles through cables. in the middle;
A24) where the UUV feeder (29) comprising a main hull (29.1), because it includes at least: control means, artificial vision and sonar electronics (not shown), a pair of thrusters (29.3), two lower pairs of front and rear wheels (29.7), a series of batteries (29.5), and a series of induction batteries (29.6) to power the other vehicles;
A25) where the USV organizes cables (33) that comprises a USV pontoon (33.1) and because it includes at least: control means, artificial vision and sonar electronics (not shown), a base is located on the pontoon deck sea stabilization base (51) that comprises at least three radially distributed actuators, an actuator (50.1) and sensors (50.2), and that a base rotation unit (33.2) is connected from the cover of the sea stabilization base (51), where a robot arm (33.3) is projected, and at its end an articulated pusher (33.5 and 33.6), which by means of an actuator, guides, spacer and rollers, opens like a handle, through which the cable of the system (1000), the one that lifts, moves, pushes, pulls, lets pass and brakes;
A26) to transport the system vehicles (1000) to the construction site by air, it comprises a UAV transport (21) that is coupled to a motorized lifting yoke (24);
A27) the motorized lifting yoke (24) for transporting any component of the system, which includes at least means for regulating the width of said components, motorized means for adjusting and hooking, and means for coupling to a UAV;
A28) to supply the vehicles, equipment and other units of the system (1000), comprises a transportable supply unit (23) that includes at least: a series of energy charging batteries, a tank of additive fluids and/or subtractive (23.2), and connection terminals, to make delivery, easy contacts (23.4 and 23.5);
A29) to assemble, maintain and clean the vehicles, equipment and devices of the system (1000), comprises a transportable assembly unit (22) that includes at least: a crane bridge (22.3) where rails and carts to which a robot arm (22.7) is connected and its effector is fed by the transportable supply unit (23), and which together with a UGV tool holder (20) to execute one of multiple tasks on said system components;
A30) where the UGV tool holder (20) includes at least: a mobile platform (20.1), on which a rotation unit (20.2) is arranged, from which a carousel (20.4) is projected to which radially It has a support (20.3) that holds components, vehicle assemblies and tools for assembly;
A31) to store all the components of the system (1000) and submerge them in the sea environment, comprises a transportable assembly unit over water (30) that includes: a UGV vehicle carriers (31), supply means and an overhead crane (30.3) where rails, carts and rotation units pass, where at least one clamp-type end effector (30.18) is connected, to take and transfer these components, through a motorized gate, to the sea environment;
A32) that includes a UGV vehicle carriers (31) that comprises a mobile platform (31.1) because it includes at least: a series of batteries, an adjustable support (31.2) with motorized jaws that supports at least one component of the system;
A33) the robot arm (1.2) comprises at its base a stabilization base (50) that comprises sensors (50.2) and an actuator (50.1), so that they respond and absorb the differences in height and speed of an irregular environment and rugged, while in its implementation it is based on sea stabilization base (51), so that it responds to the heaves, pitches, balance and natural oscillations of the environment;
A34) the robot arm includes an end effector, the cleaner (32) comprising a capable chamber and a cleaning roller (32.7) and: an air suction line, which extracts particles, a liquid spray line, to moisten and dilute difficult dirt, a pressurized air ejection line, to shake and loosen the dirt on the roller, a more liquid air suction line and a seal (32.8) that is perimeter to the entire assembly to suck and extract excess liquid plus dirty air;
A35) the supplies or extraction of fluids and energy load power are carried out from the centralized mobile reel units (700A and 700B) that include reels that feed cables, hoses and ducts, according to the maneuvers in the corresponding environment, where said units centralized mobile reel (700A and 700B) can be located on land, in the air, over water and under water, nearby or installed on site;
A36) supplies of objects are made from an object dispenser (not shown), located next to centralized mobile reel units (700A and 700B) that include: one or several lines of ducts or hoses, grippers, jaws, a capsule plunger and rotation tables;
A37) where, the cables comprise a plurality of sensors encapsulated (56, 57, 58, 61, 62) on the wiring that are arranged along and on the construction site (63) configured to monitor its position, movement and emit signals to the control unit (100, 101, 102) and to control base (1001);
A38) where, the encapsulated sensors on the cables and on the construction site, deliver signals, because it includes; a multiplicity of sensors so that the control unit (100, 101, 102) establishes communication and desired action for the stabilization of the equipment and equipment of the system (1000);
A39) the control units (100, 101, 102) for the operation of the system (1000) are configured for flight maneuvers, navigation maneuvers, forward and lateral sonar emission, immersion, propulsion, communication, monitoring, operation of tasks and control; and
A40) a Wi Fi link, which allows data to be sent to the cloud and improve operations through artificial intelligence.

### Detailed Description of the Vehicles and Equipment.

The UPV (1) that comprises the modular portal type structure (1.1) adopts configurations according to the requirements of the task and the spatial layout where it is carried out. The modular portal type structure (1.1) are meccano-type profiles that are connected and the connectors are hidden for the free transit of the horizontal carts (1.12) and horizontal rails (1.10) that are arranged on each leg of the portal rail (1.5) forming work and operational fronts for the robot arms (1.2) that are to be arranged in a vertical perimeter work plane as well as a horizontal one up and down, thereby achieving 360° coverage of the range for the tools and effectors that are arranged in the robot arms (1.2). Likewise, extensions and cantilever rails (1.13) are connected that allow the reach of said tools to be extended, as well as effectors (1.63) to be attached to construction site or the environment. The effector tools and effectors for attachment are supplied with energy, power and additive and/or subtractive fluids by the centralized mobile reel unit (700A) and when the environment is maritime, the centralized mobile reel unit (700B) is used. These units are arranged on supports (1.6.1) that are connected to the modular portal type structure (1.1). To overcome terrain obstacles, the vehicle on each portal rail leg (1.5), by means of a linear actuator (1.5.2), extends a parallel extendable portal legs (1.5.1) which at its end is connected to a wheel (1.5. 3) motorized, and from the lower section on each portal rail leg (1.5) a support (1.5.4) is projected where another shorter extensible leg is arranged, which alternate to extend and retract and overcome an obstacle without losing control vehicle balance.

The UPV wiring (1A) is a configuration that has a wired supply from a vehicle or power unit and also has at least one cantilever rail (1.13). This vehicle includes a cable entry (1.15), flexible elbow cable guide (1.9) located in the upper part of the modular portal type structure (1.1), where the supplies reach directly to the tools of the robot arms (1.2).

The UPV larger span and wiring (1B) is a configuration that, like the UPV wiring (1A), has a wired supply, and its configuration has a larger span, where the modular portal type structure (1.1) has a horizontal beam that joins the portal rail legs (1.5) longer and more robust. In another embodiment, this horizontal beam is telescopic, because it comprises a tubular profile where a smaller section slides using a linear actuator and skates between them, and the portion of the rail where the robot arm carriage slides allows the necessary reach for the task. under the portal.

The UPV (1C) that comprises a pile presser (1.14) that allows driving piles or vertical profiles of structures, for this purpose a hydraulic power unit (not shown) is included in the supply unit (1.6) that comprises a command that It is operated by the control unit (100 and 101). The pile presser (1.14) is connected to the portal rail leg, through connection (1.14.4), where a jaw (1.14.2) receives a pile (601) that is slid downward by means of a cylinder (1.14.1) passing through a centerer (1.14.3) that will bury it, drive it into the ground.

The UPV with conveyor belt (1D) that comprises a conveyor belt (1.19) that allows the different objects that the robot arms (1.2) collect and deliver to it to be transported on the belt. The belt is connected by a support to the modular portal type structure (1.1) and where the reduction motor, pinion, chain and means to regulate its tension are arranged, and a multiplicity of sensors and cameras to determine and measure the material to be transported (weight, humidity, color, etc.). The drive system is operated by the control unit (100 and 101). Other embodiments will transport the material with: rollers, chains, Teflon bands, etc. Other embodiments will also have covers and guards to prevent the escape of dust. In this case, the suction ducts may be sent to a bag filter, a fan and later to a chimney, located in the same vehicle, in a support vehicle or at a fixed station. Other realizations will have a gas mitigation system. The characteristics will depend on the type of material and granulometry, and other factors. It also includes UAVs, which allow extra range and collection in spaces confined at height; Said UAVs are connected to the centralized mobile reel units (700A and 700B). The UAV multitasking (10) comprises a robot arm (1.2) and at its end functional and operational tools, while a UAV organizes cables (11) manages the aerial cables (1.18) to avoid dangerous maneuvers.

The UPV (1E) is a sea configuration of the UPV (1) that includes the extendable portal rail legs (1.5) and the sea stabilization base (51). In this configuration, the operation of the control unit (101) is essential for the coordination of the extendable portal rail legs (1.5) and the sea stabilization base (51), in order to absorb the natural movements and accelerations of the waves, in addition to including a multiplicity of sensors and processing data on parameters such as: wind speed, delta of a floor level in a virtual construction plan, water movements on a vertical and horizontal axis, and acceleration among others.

The UPV larger span and wiring (1F) is a larger sea configuration wired for floating solar panels. The modular portal type structure (1.1) has a longer and more robust horizontal beam that joins the portal rail legs (1.5), and is braced to increase its efficiency and lower weight. In this configuration the horizontal rail is longer and has at least one robot arm (1.2). This horizontal rail can also be made up of sections and in said sections at least one robot arm (1.2) can be arranged. This vehicle comprises an entrance for intelligent sea wiring (54), cable guide, the flexible elbow (1.9) located in the upper part of the structure, the cables (1.16) pass through a cable chain and reach directly to the tools on robot arms (1.2).

The UPV wired (1G) is a wired sea setup for floating solar panels. It has the same requirements as the UPV larger span and wiring (1F) and is large enough to pass through the technical corridors of a floating photovoltaic plant.

The UPV larger span and wiring (1H) is a larger configuration and wiring for solar panels covers canals and highways. Because the canals and highways have a considerable width, it implies increasing the modular portal type structure (1.1) and the horizontal beam that joins the portal rail legs (1.5) to be longer and more robust, and which is braced, as well as the structure of a bridge, pedestrian walkways that cross a highway or bridge beam of an overhead crane. Lanes and rails are arranged like overhead cranes, the electrical power of the driving system is increased and hydraulic power is used in the actuator system for wheel extensions. The movement of the legs and wheels is carried out laterally and parallel to the canal and highway without interfering with the photovoltaic project and civil construction site. Another embodiment has a technical corridor with rails to replace the wheels with train wheels, including driving wheel and induced wheel. Another embodiment has a technical corridor on the same structure of the photovoltaic project, reducing the height of the equipment's legs. To the above, in another embodiment, a rail is provided and the wheels are replaced with train wheels.

The UPV underwater (1J), which comprises a supporting structure (1.59) connected to the modular portal type structure (1.1) to which are connected: a main hull (1.52), foam flotation modules (1.53), four thrusters (1.54) and four vertical thrusters (1.55), a centralized mobile reel unit (700B) and a supply unit, this supply unit comprises a reservoir for additive and/or subtractive fluids (1.58), a structure (1.59) and reel (1.60) that is on a supporting structure (1.61), a series of batteries (1.56) for propulsion and a series of batteries (1.57) for the arms and tools. The vehicle includes a control unit (101), artificial vision unit (1.51). The cables enter through an elbow guide (1.64) connected to the modular portal type structure (1.1) to the supply unit. The centralized mobile reel unit (700B) feeds two robot arms (1.2) to carry out the tasks and two robot arms (1.62) and effectors (1.63) to attach to a construction site or the environment.

The robot arm (1.2) comprises: an omnidirectional video camera, an array of cameras, a fluid pump (not shown) additionally close to the supply unit (1.6). Furthermore, it comprises at its end: an effector, a tool or a spray nozzle that will respond to the control unit (100 and 101). The robot arm (1.2) can perform additive and subtractive tasks, use tools, manipulation or inspection means.

The UAV reviewer (2) comprises a series of high-resolution thermal imaging cameras, multispectral cameras, a large data volume storage and communication unit, an antenna to send data in a 5G network (fifth generation of mobile networks) to the Cloud (1009) that together with Software (1008) generate 3D photogrammetric and thermographic models. Which allows surveys and contrasts to be made between one temporal event and another, and to carry out more precise inspections.

The UGV reviewer (3) comprises a UGV (3.1) where a pedestal (3.2) is projected where a linear actuator (3.3) extends, at the end of which a rotation unit (3.4) is connected where the vision unit (3.4) is arranged. 1.8). These extension and vision means allow establishing coordinates, reviewing, inspecting and contrasting the tasks, positions, and movements of the other vehicles in the system. Another embodiment has a robot arm with a greater degree of freedom to direct the vision and lighting means, in construction site that are difficult to access for inspection. This vehicle uses a battery and additionally an induction battery that are recharged. In other embodiments, the spotlights are supported and motorized independently of the extension means. This vehicle is supplied with wireless charging power by UGV wireless feeder (6) and other wired embodiments from the UGV feeder (8).

The UGV manipulator (4) comprises a UGV (4.1) where a robot arm (1.2) and a vision unit (1.8) are connected. Tools and effectors are arranged on the robot arm (1.2). This vehicle and the robot arm (1.2) are supplied with wireless power charging power by the UGV wireless feeder (6) and in other embodiments by cable from the UGV feeder (8), while the supply of additive and/or subtractive fluids by the UGV feeder (8) or from the transportable supply unit (23).

The UGV loader (5) comprises UGV (5.1) and maintains the configuration and implementations of the UGV manipulator (4) and must additionally move, load and unload material. Then, it has a container and a load cell, cameras and proximity sensors to determine the load of material and containment means to prevent the transported material from falling. Other embodiments have a loading platform that can be tilted and rotated.

The UGV wireless feeder (6) comprises UGV (6.1) and a vision unit (1.8). It has an induction battery (1.6.6) that charges or recharges in the UGV feeder (7). This vehicle allows the power load to be distributed to the other vehicles in the system. This smaller vehicle can travel in small spaces where other charging vehicles cannot.

The UGV feeder (7) comprises UGV (7.1) and a vision unit (1.8). It comprises a tank of additive and/or subtractive fluids (1.6.3) and easy contact (1.6.9) to make delivery, a series of batteries (1.6.4) and a series of induction battery chargers (1.6.5). The induction battery (1.6.5) is located downwards, hanging from an adjustable arm from the vehicle chassis, while the easy contact (1.6.9) is located at the end, also on an adjustable arm. The tank of additive and/or subtractive fluids (1.6.3) includes expulsion pumps for the additive fluids and suction pumps for the subtraction of fluids.

The UGV feeder (8) comprises a vision unit (1.8). It comprises a UGV vehicle (8.1) on which a supply unit (1.6) is projected that includes a tank of additive and/or subtractive fluids (1.6.3) and inside a pump (1.6.7) and a series of batteries (1.6.4), and the centralized mobile reel unit (700A) is also projected, which includes a reel (1.6.2) and a motor and reducer that, operated by the control unit (100), allow the delivery of cables (1.15) to the other vehicles in the system. These supply lines end in easy contacts for delivery to the other vehicles or units, an easy contact (1.6.8) for energy charging power and an easy contact (1.6.9) for additive and/or subtractive fluids.

The UGV organizes cables (9), includes a vision unit (1.8). It comprises a UGV vehicle (9.1) on which a pedestal (9.2) is projected from which a rotation unit (9.4) extends by means of a linear actuator (9.3). On the rotation unit (9.4) a frame with rollers and gripper (9.5) is connected, inside which the cables (1.15) are allowed to pass or be stopped. The lower roller is motorized while the other is driven, the lower roller remains fixed, while the upper roller is driven, and can move against the other, which allows the cable to be braked. The motorized lower roller and the driven roller by exerting a certain pressure on the cable, the cable is braked, and also if the roller is rotated the cable advances. The advance can be in one direction or another, which allows the cable to be delivered and removed.

The UGV organizes cables (9A), maintains the same logic of the UGV organizes cables (9), which is a configuration for rough terrain with ditches that also has a handle that allows you to take a cable that is on the ground and continue guiding it. It comprises a UGV (9A.1), at the top there is a base rotation unit (9A.2) on which a robot arm (9A.3) is connected, which at its end has a rotation unit (9A. 4), on this a fixed lower cable pusher (9A.5) is connected to which it is articulated and linked by an actuator (not shown) to an upper press cable pusher (9A.6) from which a spacer is projected (9A.7) which has a sheave (9A.8) at its end. When the cable pusher is open with a small plate on the edge (not shown) and as the robot arm (9A.3) allows it to reach the ground, with a gripping movement, taking advantage of the plate, it can take and insert the cable and then close with the actuator (not shown) the upper cable pusher press (9A.6) against the lower one. While the UGV (9A.1) on the lateral part is located four independent legs (9A.9), one in each corner, each of which has a base rotation unit (9A. 10) abductor, a unit of base rotation (9A.11) lift, a knee rotation unit (9A.12) lift and a wheel rotation unit (9A.13) where a wheel (9A.14) is located, thereby achieving a type vehicle spider. The vehicle allows you to take the cable from the ground and guide it, orient it in a horizontal direction, right and left, height, forward movement, pulling, pushing and braking, in addition to the position of the vehicle that can overcome ditches in the ground.

The UGV distributor (12) comprises a vision unit (1.8). A container (12.2) is located on the UGV (12.1) that includes a motor vibrator and multiple sensors, and a conveyor belt (12.6). The conveyor belt is connected to the UGV deck with at least two front linear actuators and at least one rear linear actuator (12.7), thereby achieving a tilting conveyor belt. Towards the bottom of the chassis, two front legs and two rear legs (12.3) are located, from each one, an extendable leg (12.4) is projected and at its end a wheel (12.5). Between the conveyor belt and the container, a robot arm (1.2) with an end effector (1.2.1) and functional and operational tools is located to be able to select the objects that will be placed in the container or on the conveyor belt. One embodiment will have a built-in battery while another charges power via cable to the UGV feeder (8). The UGV distributor (12) and the robot arm (1.2) with end effector (1.2.1) can have tools with additive and/or subtractive fluid supplies from a small tank in the UGV vehicle, from UGV feeder (8) or from the transportable supply unit (23).

The UGV loader (13) comprises, a UGV (12.1) where they are located, a vision unit (1.8) and a container (12.2) that includes a motor vibrator and a multiplicity of sensors. Towards the bottom of the chassis, two front legs and two rear legs (12.3) are located, from each one, an extendable leg (12.4) is projected and at its end a wheel (12.5). Other embodiments have means to rotate, extend, turn or tilt the hopper and also have a gate, which is achieved with linear actuators and rotation units.

The USV feeder (14) comprises a vision unit (1.8) and a control unit (101). A tank of additive and/or subtractive fluids (14.5), a series of batteries (14.8) and a centralized mobile reel unit (700B) are located on the pontoon-type boat (14.1). A structure (14.2) is projected upward where a series of solar panels (14.7) is located. The centralized mobile reel unit (700B) comprises a support (14.3) and a reel (14.4). From the tank, a recirculation pump (14.6) is projected downward and submerged below sea level, and an induction battery charger (14.9) is located under the pontoon. The series of solar panels (14.7) makes it possible to supply energy for the load, while the recirculation pump (14.6) makes it possible to supply water, which must be treated and, according to the requirements of the task, is stored or used continuously.

The USV self-stabilized buoy (15) comprises a hull (15.1) where a tower (15.2) is projected and on the upper part a monitoring station (19) and around the tower, a series of solar panels (15.4). Between the hull and the tower, they are distanced by a sea stabilization base (51) that includes three actuators (50.1) arranged radially, and where the gap that allows these to be moved closer and further away, perimeter, is covered by a bellows (15.6), Also around the hull, a multiplicity of sensors (15.3) project towards the seabed, and an induction battery charger (15.5) is located under the hull. The monitoring station (19) that includes: a vision unit (19.1), a control unit (101) and a set of high-power LED spotlights (19.2) and a laser pointer (not shown). The multiplicity of sensors (15.3) arranged downwards, in addition to sensors on the tower. To measure its dynamics in the environment, it has gyroscope accelerometer sensors. This monitoring of parameters allows establishing environmental conditions in sea and underwater construction site. This USV self-stabilized buoy (15) allows it to be part of the location system of the other vehicles under the sea, of the GIB (which means “GPS Intelligent Buoy”), since it includes the transducers and GPS (which means “Global Positioning System”). This vehicle must be stable because it delivers task parameters in sea and underwater construction site, where the instrumentation and sensors must be stable. It must also be stable because the vision and lighting means are directional to a sea construction site, which implies better performance, shorter delivery time in sweeping and data projection. The control unit (101) allows the three actuators (50.1) to operate according to the sensors and maintain the horizontal waterline of the vehicle. Another embodiment includes a propeller, batteries to advance to a defined area and anchoring means to anchor.

The UUV autonomous multitasking (16) comprises, a UUV (16.1) that includes: an artificial vision unit (1.8), a control unit (101) in the front, two robot arms (16.3) each with an effector of fixation (16.4) in the upper front part, a robot arm (1.2) with functional and operational tools, end effector (1.2.1) in the lower part, and an induction battery (16.2) in the upper part. The body (16.1) includes a series of vertical and lateral thrusters, foams, batteries typical of an underwater vehicle, and also includes tanks for an additive and/or subtractive fluid, a drive pump for the additive fluids and a suction pump for subtractive fluids. The fixing effector (16.4) is configured according to the task and the maneuver of the vehicle, if it is required to be attached to a construction site with metal structures, then it will have an electromagnetic effector, while if it is required to be attached to concrete of a foundation it will have suction cups. The robot arm (1.2) and the end effector (1.2.1) will have tools according to the tasks to be performed, material input such as welding, material removal, such as a drill, etc., if the task to be performed warrants it, it can be take water from the environment, using a pump outside, to carry out a cleaning task with pressurized water. The tools and effectors are powered by underwater wiring (1.17) from the fluid and power reservoirs. Underwater wiring (1.17) includes cables, hoses and ducts. The control unit (101) together with software establishes the reading of parameters of the environment, the construction site, and operates the movements of the thrusters, arms and tools. The power is recharged using the induction battery (16.2) in underwater stations, in the USV feeder (14) and in the USV self-stabilized buoy (15). Other embodiments have the arms and effectors both to perform tasks and to be attached, inverted, according to the configuration and spatial layout of the construction site and the task to be performed. Other embodiments increase the number of arms and effectors, as well as the number and size of reservoirs.

The UUV wired multitasking (17) has a configuration similar to the UUV autonomous multitasking (16) which is additionally supplied by cable. Which includes: a body (17.1), an artificial vision unit (1.8), two robot arms (17.3) each having a fixation effector (17.4), a robot arm (1.2) with functional and operational tools, end effector (1.2.1). The tools and effectors are supplied through the underwater wiring (1.17) that enters through a guide at the rear, elbow (17.2).

The UUV organizes cables (18) comprising a body (17.1), an artificial vision unit (1.8) and at the bottom a robot arm (1.2) with a gripper, end effector (1.2.1). On the back of the body (17.1) a guide for the entry of cables into the elbow (17.2). The robot arm (1.2) can have a series of grippers, end effector (1.2.1), according to the subsea cables (1.17) that need to be handled. The end effector gripper (1.2.1) includes a pair of driven sheaves, which are grooved, at the bottom and a pair of motorized sheaves (not shown), also grooved, at the top. The handle allows the mobility, braking and advancement of the cables being handled. The power cable is bifurcated before reaching this vehicle, one line of power cables enters through the elbow (17.2) and the other line goes to one or more other vehicles and this last line of cables is handled by the grabber, end effector (1.2.1). In another embodiment this vehicle is powered by another vehicle without relying on a branched cable line.

The monitoring station (19) comprises an artificial vision unit (19.1), a series of high-power LED spotlights (19.2), a series of induction battery chargers (not shown) and a laser pointer (not shown). A control unit (101). The artificial vision unit and the series of high-power LED spotlights (19.2) are arranged on an articulated and motorized base to be directed to a specific area of the construction site or an environment. All equipment is supported on a platform connected to the seabed or on the construction site. It also includes a multiplicity of sensors, which measure water parameters; temperature, salinity, carbon dioxide, dissolved oxygen, acidity, sea current, water speed, turbidity, proximity of objects, etc.

The UGV tool holder (20) comprises a mobile platform (20.1), on which an artificial vision unit and a series of batteries (not shown) are arranged, a rotation unit (20.2) from which a carousel (20.4) is projected to which a series of supports (20.3) are arranged radially to which a jaw (20.5) is connected at its end. The vehicle comprises an easy-to-recharge contact to charge power at its rear and go to a station to be recharged. It can also be charged by a UGV wireless feeder (6). It also includes a floor fixing system, using four motorized hooks that are coupled by rotating to slots or connection ears in the floor. The clamp is motorized and some have a lower horizontal tray, below said clamp, to support the equipment that you want to hold. The jaws are arranged individually and in pairs depending on the equipment to be held. There are jaws that are also aligned and that will work simultaneously, they will have an optimal distance for the equipment and devices that they hold, transport and arrange to be delivered in the assembly process within the transportable assembly unit (22). For vehicle movements, carousel rotation and gripping of the jaws, a plurality of sensors is included for detection of delivery, proximity, positioning, tightening, adjustment and release. This embodiment, to rotate the carousel and grip the jaws, works through an electrical system.

The UAV transport (21) is connected to the motorized lifting yoke (24), which can be coupled to the other vehicles of the system to transport them to a larger vehicle, to a construction site or to a specific place, on the ground, at height, above the sea, for example, moving from a truck trailer to a high-rise construction site deep in the sea.

The transportable assembly unit (22) comprises a container module (22.1), an artificial vision unit, a series of batteries (not shown), tanks for additive and/or subtractive fluids, and a crane bridge (22.3). In the crane bridge (22.3) there is a main rail (22.4) where a main rail (22.5) is projected, where a robot arm rail (22.6) runs, to which a robot arm (22.7) is connected and tools are connected at its end functional and operational, the effector (22.8). Outside, preferably above the container module, a series of solar panels (22.9) store energy for operations. On the walls of the container module, there is a simple contact (22.11) for the energy charging power and a simple contact (22.12) for additive and/or subtractive fluids. Outside, in the upper corners, lifting lugs (22.2) are located for lifting and transfer maneuvers. The rails are motorized and the rails and rails work with cams and gears, also motorized gears. At the base of the robot arms (22.7) it comprises a rotation unit that allows it to rotate 360°. The tanks for additive and/or subtractive fluids have pumps to deliver the fluids to the effector (22.8). Vehicles and equipment are inspected, tested, repaired, assembled, disassembled and cleaned. Liquids and surpluses, resulting from maintenance, are drained from a grid-type floor to a channel, where solids, contaminated liquids and water are filtered and separated, and then stored and recirculated for reuse. An automatic gate that gives access to a takeoff platform (26) and/or floating takeoff platform (27), for the entry or dispatch of vehicles and equipment. The unit additionally, for power supply and additive and/or subtractive fluids, is connected to a transportable supply unit (23) by means of a single contact (22.11) for the power supply and a single contact (22.12) for fluids additives and/or subtractive.

The transportable supply unit (23) comprises a container module (23.1), an artificial vision unit, a series of batteries (23.3) and a series of additive and/or subtractive fluid tanks (23.2) that includes pumps. impulsion and/or suction. From the supplies they reach the wall where the easy contact (23.4) is located for energy, charging power and the easy contact (23.5) for additive and/or subtractive fluids.

The motorized lifting yoke (24) comprises a yoke (24.1), a machine vision unit and a series of batteries (not shown). The yoke is a frame with two main stringers, on each side of the yoke an adjustable support (24.2) that slides and adjusts to the required width by means of a cylinder (24.9), at the end of the support a hook (24.5) rotates by means of an engine (24.3) and a transmission (24.4). Said hook is attached to the lifting ear (25) which must be installed on any of the vehicles or equipment of the system. In the upper part of the yoke (24.1), four shock absorbers (24.7) are located, two in the front and two at the back, and on each one, an actuated jaw, clamp (24.8) which grips the landing gear (21.1) of a UAV, UAV transport (21). The sequence to be able to lift a vehicle or equipment is to place the motorized lifting yoke (24) first on the landing gear of the UAV and then these are directed to the vehicle or equipment that will have the lifting ears (25). In another embodiment, the hook (24.5) and the lifting ear (25) may have a conical portion or a portion with an electromagnet to ensure engagement and fit. Also the adjustable support that slides and adjusts manually can be replaced by a linear actuator and sensors to automatically adjust to a structure to be lifted. The motorized lifting yoke (24) is not limited to moving vehicles and equipment, it can be used to move tanks, packages of materials, etc. A more robust version with more powerful propulsion means can lift a 40-foot maritime container, etc.

The UUV feeder (28) comprises, a main hull (28.1) with an immersion system, a foam flotation module, an artificial vision unit (28.4), a reservoir for additive and/or subtractive fluids (28.6), a series of batteries (28.5) and a centralized moving reel unit (700B, not shown). It comprises a series of thrusters (28.3), vertical and horizontal. At the bottom it includes two front wheels (28.7) and two rear wheels. At the back there is a guide for cable entry, elbow (28.2) and at the front there is a supply delivery connection guide (28.8) to feed the other vehicles in the system by cable. The centralized mobile reel unit (700B, not shown) comprises a support and a motorized reel (not shown) and is located outside to make delivery as other vehicles require. In another embodiment the centralized moving reel unit (700B, not shown) arranges the incoming power cable, then as it advances it unwinds cable and as it approaches the point of origin it coils cable.

The UUV feeder (29) comprises, a main hull (29.1) with an immersion system, a foam flotation module, an artificial vision unit (29.4), a series of batteries (29.5) and an induction battery (29.6). It comprises a series of thrusters (29.3), vertical and horizontal. At the bottom it includes two front wheels (29.7) and two rear wheels. On the back there is a guide for cable entry, elbow (29.2). The induction battery (29.6) is located at the front to power the other vehicles in the system.

The transportable assembly unit over water (30) comprises a container module (30.1), an artificial vision unit, a series of batteries (not shown), tanks for additive and/or subtractive fluids, a centralized mobile reel unit (700B) and an overhead crane (30.3). In the upper part there is a set of solar panels (30.9) and in the four corners some lifting ears (30.2), in the four lower corners some floats (30.21) and in the lower part a motorized gate (30.19). The unit with the overhead crane allows vehicles and equipment to be inspected, tested, repaired, assembled, disassembled and cleaned. On the overhead crane (30.3) there is a main rail (30.4) from which a telescopic rail (30.5) is projected, where a robot arm rail (30.6) runs, to which a robot arm (30.7) is connected and at its end functional tools and operational, a robot arm effector (30.8). Also, on the overhead crane (30.3) there is a horizontal rail and a rotation unit (30.17) where a pair of rails and clamp-type end effector (30.18) are connected. The centralized mobile reel unit (700B), the additive and/or subtractive fluid reservoir (30.14) and the series of batteries (30.16) are located on a structure (30.11). The centralized mobile reel unit (700B) comprises a motorized support (30.12) on which a motorized reel (30.13) is connected, which arranges the cable to feed the vehicles that are released from this unit. The additive and/or subtractive fluid tank (30.14) comprises a drive pump (not shown) for additive fluids and/or a suction pump (not shown) for subtractive fluids. Outside below sea level there is a recirculation pump (30.15) and from the tank of additive and/or subtractive fluids (30.14) connection means for feeding and also for a transportable supply unit (23) are projected to the outside.

To join the unit to the floats (30.21) they are connected by a structural spacer, a structural link (30.20).

The transportable assembly unit (22) and the transportable assembly unit over water (30) can be joined together to form an assembly and delivery ship to environments: surface, sea, underwater, land and air.

UGV vehicle carriers (31) comprises a mobile platform (31.1), an artificial vision unit, a battery (not shown), an adjustable support (31.2) with motorized jaws (not shown) that supports one or more vehicles of the system. The adjustable support (31.2) comprises a structure with support trays and spaces that are the volume capable of holding the vehicle or equipment that is to be supported. The motorized jaws grab a suitable area in the vehicle or equipment, considering: center of gravity, ease of gripping, moving and releasing. Like the UGV tool holder (20), it includes a floor fixing system, an easy contact for energy recharging, it charges power and can also be charged by a UGV wireless feeder (6).

The cleaner (32) comprises, a body (32.1), a machine vision unit (not shown), a cleaning roller (32.7) and a seal (32.8). In addition to: an air suction line, a liquid spray line, a pressurized air ejection line and an air plus liquid suction line.

The air suction line includes: a flexible air outlet duct (32.12) that connects to a distribution chamber (32.2) that branches into at least three suction ducts (32.3) and each of which at its end it has an air suction nozzle (32.9). The liquid spray line includes: liquid hoses (32.11) that branch into at least three lines and each of which at its end has a liquid spray nozzle (32.4). The pressurized air ejection line includes: air hoses (32.10) that branch into at least three lines and each of which at its end has pressurized air ejectors (32.5). The air plus liquid suction line includes: air suction hoses (32.14) that branch perimeter to the roller in at least six lines, each of which at its end has a liquid suction nozzle (32.13) and further towards the outside of the roller a seal (32.8) that is perimeter to the entire assembly. The lines are located inside above the cleaning roller which are then arranged parallel to the flexible air outlet duct (32.12) except for the last suction line for more liquid air which is located coplanar to a given work plane. due to the flexibility of the roller filaments. A controller (32.50) operates: the movement on the surface to be cleaned, the rotation of the roller and the lines. The air suction line allows the surface to be cleaned of suspended particles. The liquid spray line allows you to integrate an aqueous solution or detergent for washing. The pressurized air ejection line allows loosening dirt and impurities from the roller and loosening difficult dirt on the surface. And the liquid air suction line allows excess liquid and dirt to be extracted, so that the excess does not damage critical components on the surface, for example, circuit connections of a photovoltaic panel. The cleaning roller (32.7) is driven by a rotation unit (32.6) and reduction box, to control RPM and make cleaning protocols.

The USV organizes cables (33) comprises a USV pontoon (33.1), an artificial vision unit (1.8), a sea stabilization base (51), an articulated arm and a cable pusher. To handle cables on the sea surface. A sea stabilization base (51) is located on the pontoon deck, comprising at least three radially distributed actuators, an actuator (50.1) and an IMU (50.2) (gyroscopes, accelerometers and an electronic compass). From the cover of the sea stabilization base (51) a base rotation unit (33.2) is connected, where a robot arm (33.3) is projected, at its end, a rotation unit (33.4) where a cable pusher is arranged. fixed bottom (33.5) and that by means of a joint and actuator as a clamp, an upper cable pusher presses (33.6) where a spacer (33.7) is projected where a sheave (33.8) is located. An induction battery charger (15.5) is located under the hull. The fixed lower cable pusher (33.5) and the press upper cable pusher (33.6) allow: pushing, pulling, passing and braking the cable. While the spacer (33.7) and sheave (33.8) allow the cable to be guided and aligned before reaching the pushers. This vehicle is configured like the UGV organizes cables (9A), so the grabber allows you to take a cable that is on the surface of the sea and continue guiding it. The vehicle can handle cables on the sea surface that are directed to the air, land, over sea or under sea, to other vehicles or system units. In another embodiment the arm will have several cable managers so it handles several cables in parallel.

Fluid supplies through cables or supply hoses are carried out from the centralized mobile reel units (700A and 700B) that are located in vehicles, equipment and units, which are on land, air, over water and under water, near or installed in the construction site. They comprise a supply unit (1.6). The supply unit (1.6) comprises a tank of additive and/or subtractive fluids (1.6.3) and a series of batteries (1.6.4), and impulsion pumps to carry the additive fluids or a suction pump for subtractive fluids. They also include motorized reels (1.6.2, 1.60, 14.4, 30.13) that feed cables, hoses, corrugated ducts, flexible ducts, textile ducts, cables (1.15, 1.16, 1.17, 1.18) according to the maneuvers in the corresponding environment.

In the main multitasking vehicles, on land, on the sea surface and under the sea, it includes an object dispenser (not shown), objects that go to the tool, from the robot arm (1.2) through ducts, inside which there is a plunger or a capsule, which moves it through the conduit, these are pushed by a steel cable wound on a motorized reel, which in a direction of rotation rolls-removes as unrolls-pushes. This path can be continuous or intermittent. There are transfer points on the indicator, from one section to another until reaching the tool. Where the object is rotated, rotated and pushed, using motorized actuators: jaws, grippers and rotation table. From the tool to the dispenser, the transit of the object is in both directions, so the tool makes the exit and the entry. The motorized dispensers are vertical or concentric, depending on their geometry and arrangement.

Cables (1.15, 1.16, 1.17, 1.18) are not limited to cables and hoses, they are also ducts and conduits that allow transporting an additive or subtractive fluid, energy, power, for example: cables, hoses, corrugated ducts, flexible ducts, textile ducts. These types of cables can also carry two or more supplies in parallel at the same time, a package of cables, for example, a hose with pressurized air, a data cable, a communication cable and another power cable. Several types of cables can also be arranged in parallel, for example, a type of cable for sea requirements that branches with another for aerial requirements.

The cables (1.15, 1.16, 1.17, 1.18) comprise a plurality of sensors encapsulated on the wiring (56, 57, 58) that are arranged along and configured to monitor their position, movement and emit signals to the control unit (100, 101, 102) and control base (1001).

The sensors encapsulated on the sea and underwater (61, 62) conduit and on the construction site (63) deliver signals, because they comprise a multiplicity of sensors, among which an IMU so that the control units (100, 101, 102) establish communication and desired action for the stabilization of the equipment and equipment of the system (1000).

The control units (100, 101, 102) for the operation of the system (1000) are configured for flight maneuvers, navigation maneuvers, forward and lateral sonar emission, immersion, propulsion, communication, monitoring, task operation and system control, these are issued by a Wi Fi link, which allows data to be sent to the cloud and improve operations through artificial intelligence.

The control units allow the vehicles to be operated together with the mobile and motorized components already indicated, and thus control: the orientation in a horizontal, right and left direction, the height and advance of the cable, in addition to the position of the vehicle. The control units allow operating the mobile and motorized components already indicated, because the linear actuators and motorized rotation units have encoders.

Communication is achieved through first emission signals, second reception signals and third control signals: on land, in the air and on the sea surface, a wireless radio link (500), while, under the sea, a wireless radio link (502).

For vehicles on the ground, the vision unit (1.8) includes a series of: 3D ToF camera (which means “Time-of-Flight”), an omnidirectional camera, an array of CCD cameras (CCD, which means “charge-coupled device”), a high-resolution thermal imaging camera, multispectral cameras, a 3D scanner, a LIDAR system (which means “system for measuring and detecting objects using laser”), a set of high-power LED spotlights, radar (acronym for RADAR, which means “detection and measuring distances using radio waves”) high definition and a laser pointer (not shown).

For vehicles on the surface of the sea and under the sea, the artificial vision unit (1.8) includes: a 3D ToF camera, an omnidirectional camera, a high-resolution thermal imaging camera, an underwater 3D scanner, an underwater LIDAR system, a sonar (acronym for SONAR, which means “Sound Navigation And Ranging”) and a 3D sonar. They also comprise a control unit (101) that includes sonar electronics, forward sonar and lateral sonar emitters (not shown) and a set of high-power LED spotlights and a laser pointer (not shown).

The vehicles and equipment, depending on the environment (land, air, sea surface and undersea), comprise a plurality of sensors, to measure a plurality of parameters: wind speed, ambient temperature, air temperature, humidity, surface temperature of the objects to be inspected, color, pressure, proximity of objects and gyroscope accelerometer sensors. For underwater vehicles in particular: solid state compass, IMU, IMU with electronic compass, Doppler navigation speedometer, sonar for obstacle detection, depth sensor, measurement of electrical consumption, flood detector, etc. In particular, the USV self-stabilized buoy (15) and the monitoring station (19) measure water parameters; waves, temperature, salinity, carbon dioxide, dissolved oxygen, acidity, sea current, water speed, turbidity, etc.

For ground vehicles, the location unit (1.7) comprises a high-precision GPS (which means “Global Positioning System.”) For vehicles under the surface of the sea, the location unit (1.7) comprises the GIB. For vehicles on the sea surface, the location unit (1.7) includes the combination of the means described on land and under the sea surface.

The numbers of arms for tasks and for attachment are determined by: the type of task, the weight of equipment and supplies, ocean currents and other variables.

The vehicles on the sea surface and under the sea are fed with energy, load power and additive and/or subtractive fluids from: under the sea, by the UUV feeder (28), the sea surface, by the USV feeder (14), a vessel or pontoon, a transportable assembly unit over water (30), as well as, from an underwater or cabled station from land, on the shore, by a transportable supply unit (23), a transportable assembly unit over water (30), as well as, from an underwater station or wired from land, on the shore, by a transportable supply unit (23) or from a supply substation.

Vehicles on the surface of the sea and under the sea have propulsion systems for forward movement and direction. The following can be used: propeller and motor drives, fins or rudders with a single degree of freedom to obtain pitching, turning and rolling movements. multiple thrusters, vector thruster, where the thruster has the ability to orient itself, aquatic glider, by injection, traction with the seabed. The energy source can be through Li-Ion batteries (lithium ion battery) or fuel cells (hydrogen-oxygen).

For supplies of additive and/or subtractive fluids through the use of easy contact, it comprises: mechanical fits and stops to guide it, an elastomeric portion to absorb position differences, an electromagnetic portion to connect, and a tab that fits and rotates to be secured by a motor, all of which leave the duct area and an O-ring free for the transfer of fluids between a line in each vehicle. These easy contacts, in vehicles and units (23 and 24), are guided by an articulated arm.

The vehicles have elbow connection guides (1.9, 1.64, 17.2, 28.2, and 29.2), where the cable enters and also exits to and from other vehicles, which are flexible, but robust enough not to be damaged and extend to avoid entanglements, with themselves, for example, propulsion.

The vehicles and equipment have a series of instrumentation and a series of sensors, depending on the environment, to determine depth, pressure, altimetry, proximity of objects, underwater currents, temperature, etc.

Wheels and tires have characteristics depending on the terrain and environment. Other embodiments will use tracked tractors instead of wheels.

The vehicles, equipment and devices have been disclosed, predominantly, with electrical power and supply, other embodiments may be pneumatic or hydraulic, for these, the vehicle has the respective tanks, pumps, valves, and filters.

Power vehicles deliver power wirelessly to other vehicles, by induction on land, air and sea. The vehicles have an induction battery charger while the other one that is charged has an induction battery. Power transmission based on electromagnetic induction, induction link load energy power (501), corresponds to power transmission between a primary coil and a secondary coil, a magnet moves around a coil, generating an induced current, then, a transmitter generates a magnetic field, and a current is induced in a receiver due to a change in the magnetic field, creating energy.

Other embodiments, both in land and underwater vehicles, use a battery and have a simple contact for charging power, a contact with a magnetic portion and also an elastomer to absorb the position play, which allows it to be temporarily attached to a vehicle and recharge.

Other embodiments, both in vehicles on land and under sea, use a recharging battery that alternates, where there is always a rotating one and other replacement ones. Always considering a backup in case of main battery failure. A robot arm that places and removes a battery that is located on a battery array carousel. In sea and underwater vehicles, seals and an airtight chamber are used in the compartment where the robot arm accesses and changes the battery, while the carousel with the positive and negative connectors rotates and prevents water from entering through the seals.

Other embodiments, for feeding vehicles on land, sea surface and under sea, allow having one cable for underwater tasks, another on water, another for vehicles in flight and another for vehicles on land, then it has four centralized reel units. mobile (700B) at least.

Other embodiments, for feeder vehicles on the sea surface and under the sea, to deliver energy charging power by induction or magnetic easy contact, include an articulated arm with an anchoring and vision device to temporarily support another vehicle.

For vehicles and equipment on the surface of the sea and under the sea, it is necessary to protect the actuators and instrumentation with casings with at least IP67 or bellows (15.6) to protect them. It is also necessary to use lighter, more resistant materials, with a lower coefficient of friction and anti-corrosive materials in moving components, to maintain the performance of the vehicle. If the vehicle or equipment is in an environment with design conditions for explosives, for example, in a mining extraction environment, the electrical and mechanical components and protection systems will be resolved under ATEX explosion protection (abbreviation of the French, “ATmosphère “Explosible”, which means “Explosive ATmosphere”).

### DETAILED DESCRIPTION ACCORDING TO FIGURES

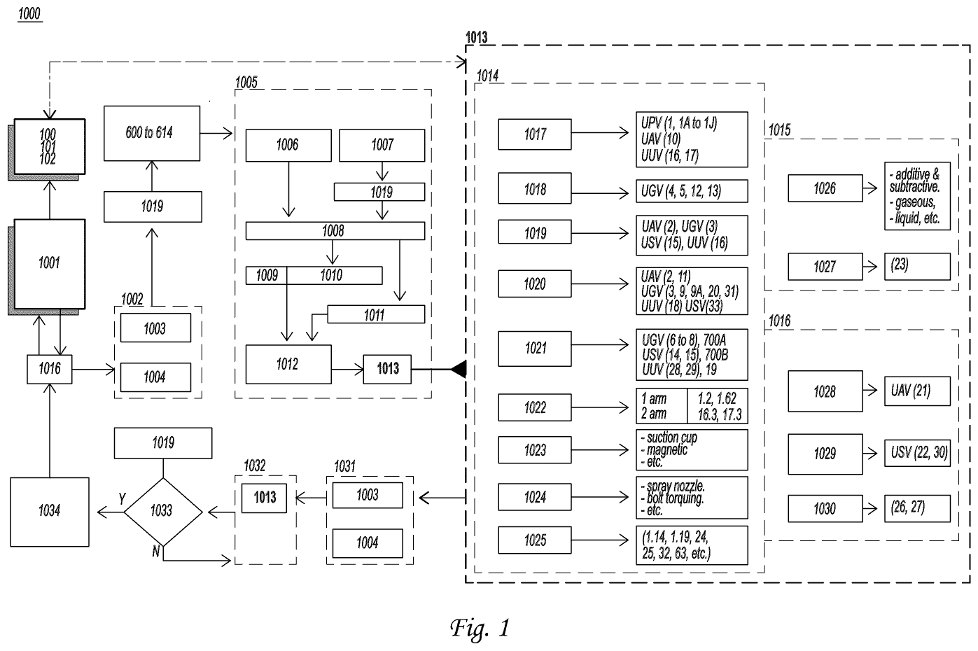

To carry out the detailed description of the preferred embodiment of the device of the disclosure, continuous reference will be made to the Figures of the drawings, of which FIG. 1 is a flow diagram of how the system (1000) operates, of which next disclosure.

A task request is received from a control base (1001) or company, then communication is established with the control unit (100, 101 and 102) in the vehicles and equipment for tasks on the work site (600 to 614) on the ground, air, over sea and under sea, and available equipment is established (1002), which chooses the availability of vehicles and equipment that is on site (1003) or sent to construction site (1004). On the work site (600 to 614) the review equipment (1019) will monitor and establish requirements diagnosis & solution (1005), then a solution can be a routine, a requirement that has a pre-established known solution (1006) or there are no precedents for known requirements and therefore to be resolved (1007). This diagnosis of requirements & solution (1005) is processed and assisted by Software (1008) that evaluates, and the solutions are shared and compared with other experiences or cases stored in the Cloud (1009) stored information that is processed and improved by Artificial Intelligence (1010). Likewise, the solutions to requirements can be carried out by an operator through remote control via telecommand (1011). In these ways, the types of tasks and actions (1012) are established and the order for the configuration of equipment (1013) is established, which is the choice of the most appropriate vehicles and equipment to solve said task.

Then depending on the tasks, the equipment configuration (1013) will choose a combination between operation equipment (1014), supplies (1015) and transportation and storage (1016). Within the operation equipment (1014) you will choose: main multitasking equipment (1017), secondary multitasking equipment (1018), review equipment (1019), support equipment (1020), feeding equipment (1021), robotic arm (1022), fixation effector (1023), end effector (1024), device (1025). Within supplies (1015) you will choose: supplies (1026) and equipment (1027). Within transportation and storage (1016) you will choose: transfer equipment (1028), configuration equipment (1029) and infrastructure (1030). Then the chosen equipment is established (1031) that chooses the availability of vehicles and equipment that is on site (1003) or sent to work (1004) and the execution of tasks is carried out (1032) which will be monitored, supervised and reviewed through task review (1033) by review equipment (1019).

When the task review is carried out (1033) and it is not under conformity “N”, the task execution must be carried out again (1032) and if it is under conformity “Y”, the task is finished (1034). Once the task is completed, transportation and storage (1016) can be carried out to move vehicles to other tasks on the work site, to another work site, back to the control base (1001), or to a transportable assembly unit (22) or a transportable assembly unit over water (30) for maintenance, cleaning or others.

The control base (1001) should be understood as the control instance that is operated from any enabled point, from a company, home, mobile device, remote manual control, etc.

The tasks to be solved that are carried out in a work site, which can be as a descriptive and non-limiting example: a structure (600), underwater structures (609), crops (613), vertical cultivation structure (612), floating structures (606), photovoltaic panel structures covering channels (608), floating photovoltaic panels (605), photovoltaic structures (602), photovoltaic panel (603) and a pile (601).

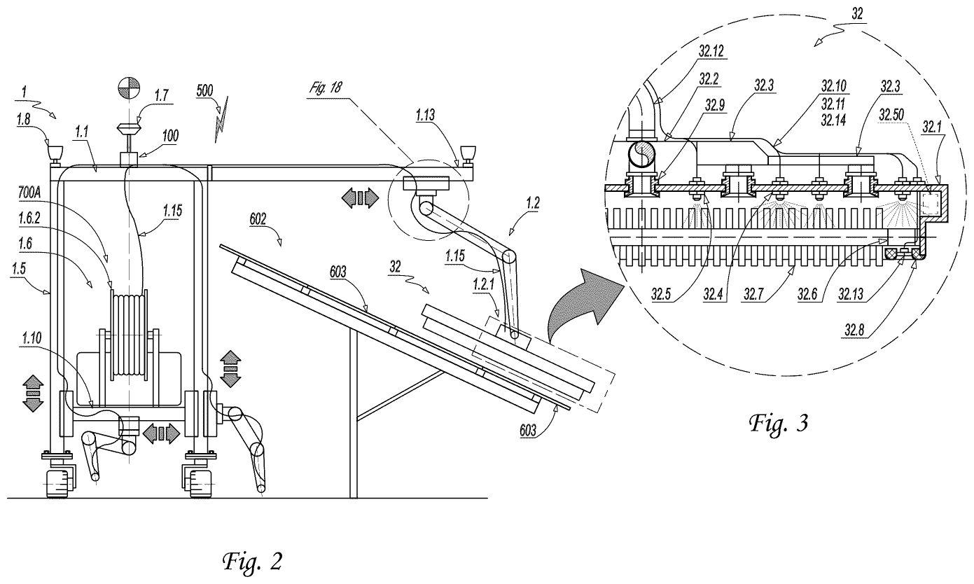

FIG. 2: The UPV (1) is doing one of the many tasks it can perform on a construction site. Illustrated is a cantilever rail (1.13) connected to the modular portal type structure (1.1) of the UPV (1). The robot arm (1.2) travels on the cantilever rail (1.13) and a cleaner (32) is connected to its end, cleaning the photovoltaic panels (603) of a photovoltaic structure (602). It can be seen that there are several robot arms (1.2) connected and that move through the modular portal type structure (1.1), simultaneously allowing the cleaning of the photovoltaic panels to perform tasks at ground level and under the photovoltaic panels. The extension, with the cantilever rail, allows tasks to be carried out beyond the 360° allowed by the modular portal type structure (1.1). In another embodiment, a telescopic articulated arm is used instead of the cantilever rail (1.13), which includes a hydraulic unit in the supply unit (1.6).

FIG. 3: shows a detail of the cleaner (32). The air suction lines, the liquid spray line and the pressurized air ejection line acting on the cleaning roller (32.7) are illustrated. Under the support line of the cleaning roller (32.7) on the surface the seal (32.8) and inside this the suction line for more liquid air, so that excess liquids do not spill.

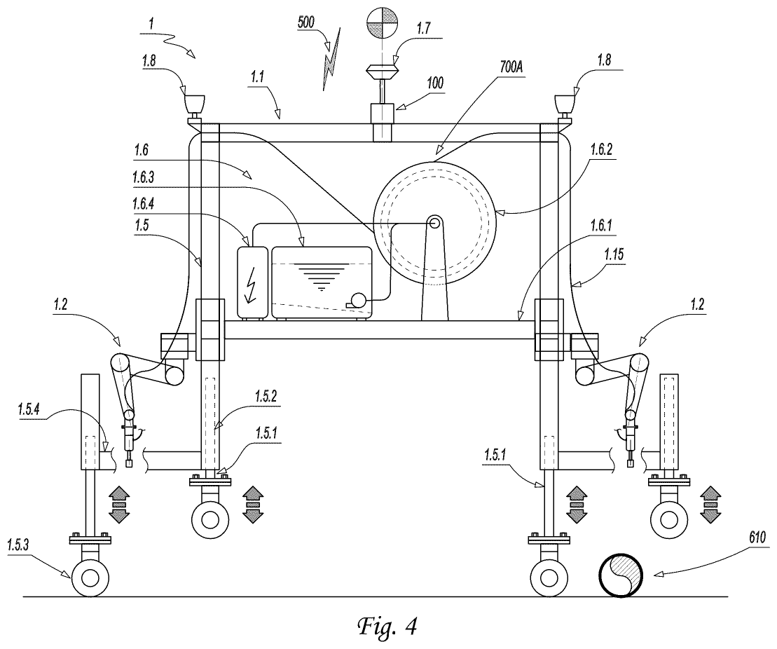

FIG. 4: The UPV (1) is overcoming an obstacle. The obstacle (610) photovoltaic farm infrastructure is illustrated, such as pipes, distribution ducts for electrical substation, treated water process network in thermoelectric plants, etc. The UPV (1) alternates a pair of parallel extendable portal legs (1.5.1) that extend through the portal rail legs (1.5), a pair to the floor while the other two are elevated, an operation that is repeated in the four front ones and in the four rear ones, allowing this obstacle to be overcome. Other embodiments will have three pairs of legs instead of four pairs.

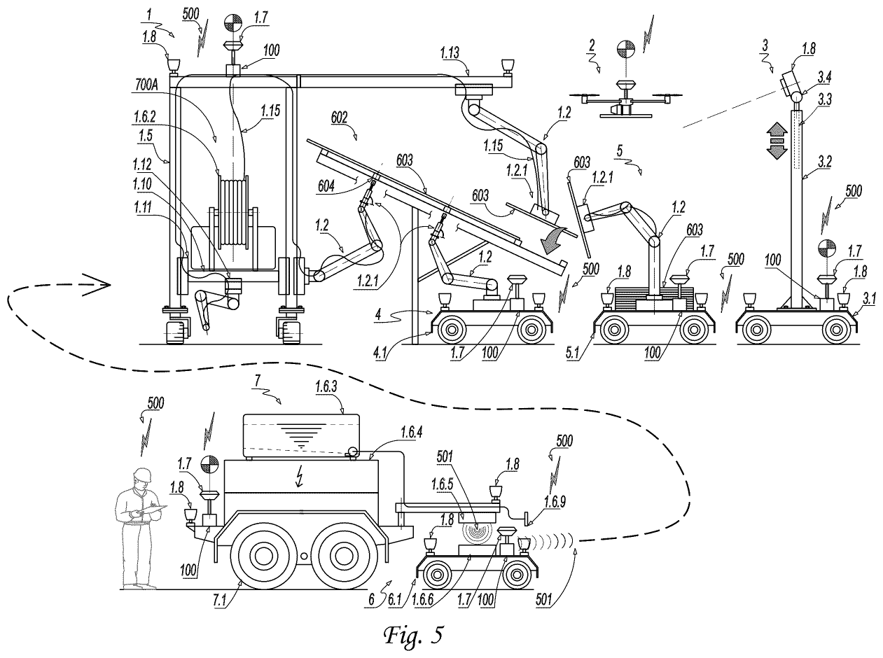

FIG. 5: UPV (1), to perform multitasking it is supported by: secondary multitasking equipment (1018), the UGV manipulator (4) and the UGV loader (5), review equipment (1019), the UAV reviewer (2) and the UGV reviewer (3), and feeding equipment (1021), the UGV wireless feeder (6) and the UGV feeder (7), in solar panel installation. The wireless recharging method is illustrated, where the UGV feeder (7) comprises an induction battery charger (1.6.5) and inductively recharges the UGV wireless feeder (6), which includes an induction battery (1.6.6). and also an induction battery charger (1.6.5) and this, in turn, recharges the other vehicles (1, 2, 3, 4, 5) with energy and charges power by induction. It is illustrated that the UPV (1) is placing a connector on the photovoltaic structure (604) using a tool, end effector (1.2.1). The UGV reviewer (3) has a panoramic view of the operation and is a reference point for the other vehicles, likewise the UAV reviewer (2) has views that the others do not achieve, improving the operation.

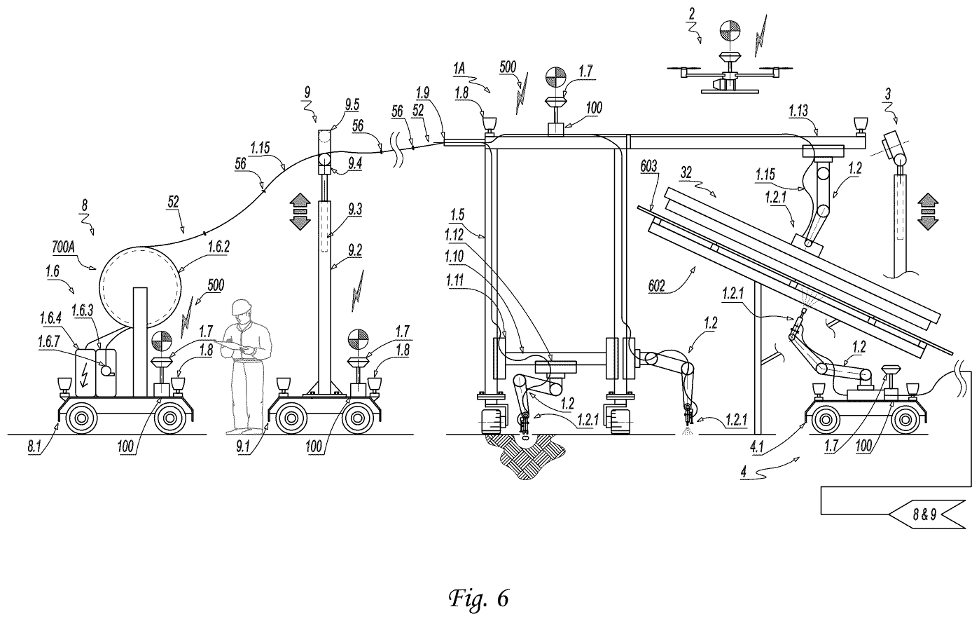

FIG. 6: Wired UPV wiring (1A) to perform multitasking is supported by: secondary multitasking equipment (1018), the UGV manipulator (4), review equipment (1019), the UAV reviewer (2) and the UGV reviewer (3), support equipment (1020), the UGV organizes cables (9), and feeding equipment (1021), the UGV feeder (8). It is illustrated that the wired UPV wiring (1A) is performing tasks: on the photovoltaic structure (602), with a robot arm (1.2) on the floor and laterally under the structure. Supporting these tasks, the UGV manipulator (4) performs cleaning under the photovoltaic structure (602). The wired supply method is illustrated, where the vehicles are fed by the UGV feeder (8) that has a supply of additive and/or subtractive fluids and charging power. The delivery of the intelligent terrestrial wiring (52) is carried out by means of the mobile reel centralized unit (700A). The wiring is managed by the UGV organizes cables (9) until it reaches the UPV wiring (1A) and the UGV manipulator (4). Likewise, the UGV reviewer (3). The intelligent terrestrial wiring (52) is illustrated, where encapsulated sensors (56) are available along the cable (1.15). The UAV reviewer (2) has views that the others do not achieve and is a reference point for the other vehicles, improving operation.

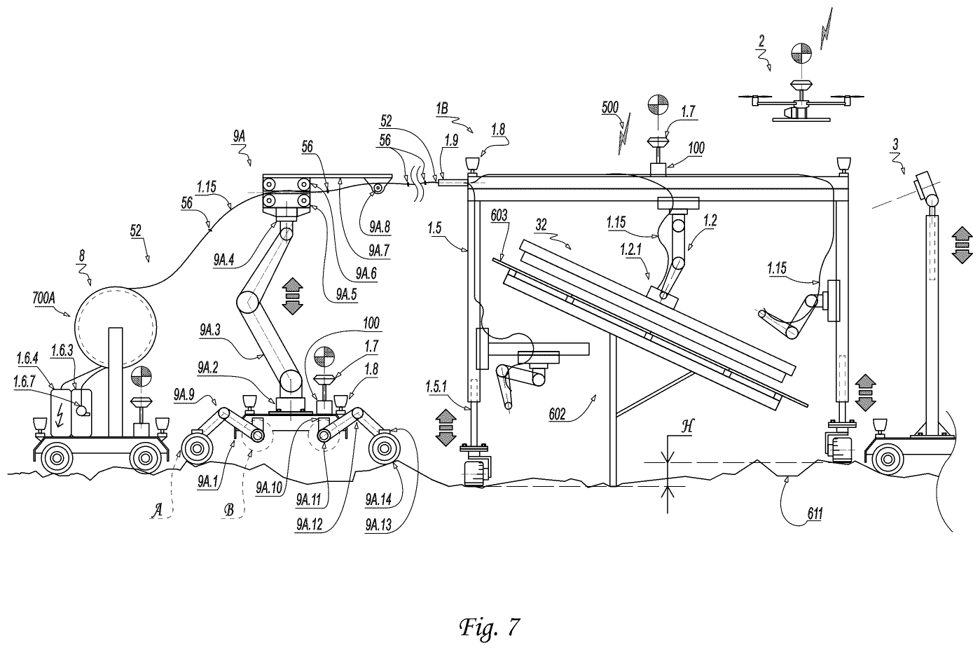

FIG. 7: UPV larger span and wiring (1B), is supported by: review equipment (1019), the UAV reviewer (2) and the UGV reviewer (3), support equipment (1020), the UGV organizes cables (9A), and feeding equipment (1021), the UGV feeder (8). It is illustrated that the UPV larger span and wiring (1B) is performing tasks: on photovoltaic structure (602) rough terrain (611) rocky terrain with slope “H”, where the portal type configuration allows the portal rail legs (1.5) to be adjust to the “H” variables and occupy a reduced space, technical corridors, on each side of the photovoltaic structure (602), and also allow the photovoltaic panels (603) to be cleaned with the cleaner (32), while the robot arm (1.2) inside the portal rail legs (1.5) allow simultaneous tasks to be carried out, for example, painting the structure, etc. The wired supply method is illustrated, where the configuration and operation is very similar to that shown in FIG. 6, additionally the UGV organizes cables (9A) allows it to be adjusted to the ground conditions since it is a spider type UGV, where “A” the independent legs (9A.9) and wheels are extended and at “B” they are retracted. The UGV organizes cables (9A), has a more robust articulated cable pusher (9A.5 and 9A.6) and a robot arm (9A.3) allows its height to be retracted and has more degrees of freedom.

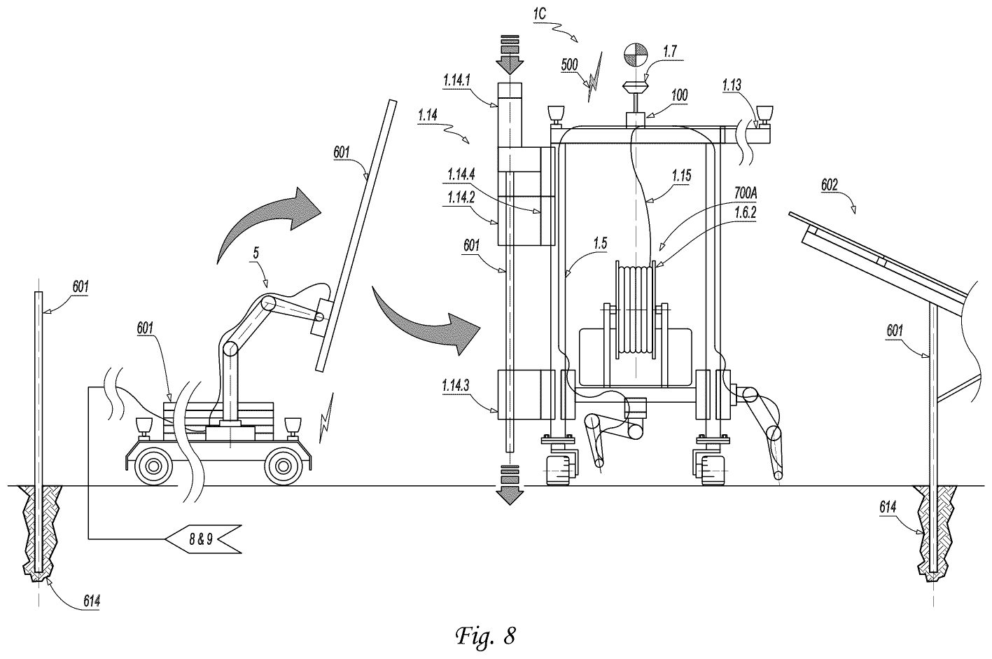

FIG. 8: The UPV (1C), with pillar installer is supported by: secondary multitasking equipment (1018), the UGV loader (5), support equipment (1020), the UGV organizes cables (9), and feeding equipment (1021) the UGV feeder (8). It is illustrated that the autonomous UPV (1C) is driving piles (601) into the ground, of a photovoltaic structure (602), and the ground is shown in section of buried pile (614). The pile presser (1.14) is connected to the portal rail leg (1.5). Also the UGV loader (5) dispenses, transfers and delivers the piles (601) to the autonomous UPV (1C) which is fed by the UGV feeder (8) and for cable maneuvers, is supported by the UGV organizes cables (9). Robot arms (1.2) that are doing tasks at floor level are also illustrated.

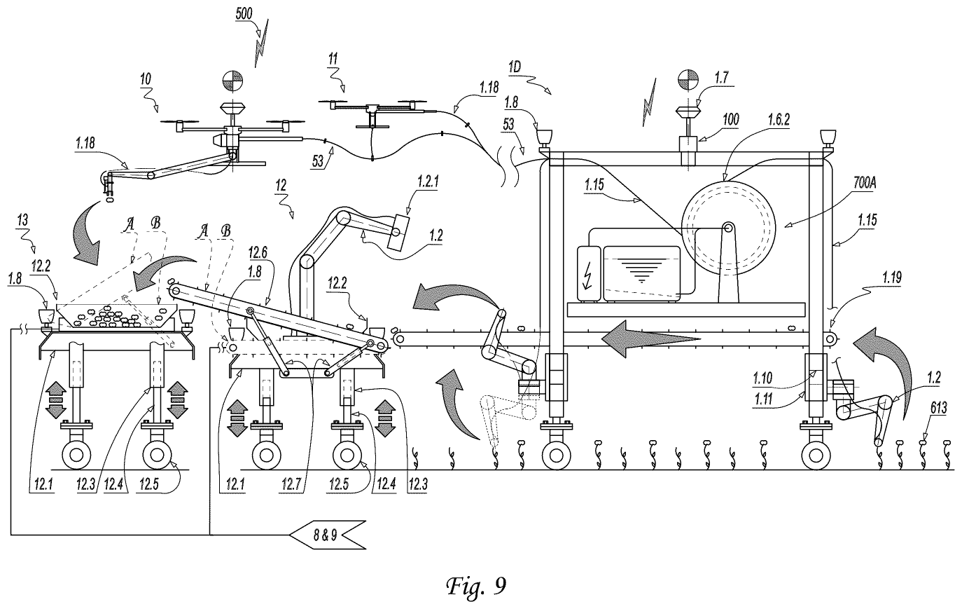

FIG. 9: UPV with conveyor belt (1D), cabled configuration, for planting and harvesting, with vehicles in air and on land, and conveyor belt equipment. The UPV with conveyor belt (1D) is supported by: main multitasking equipment (1017), the UAV multitasking (10), secondary multitasking equipment (1018), the UGV distributor (12), support equipment (1020), the UAV organizes cables (11), the UGV loader (13), and the UGV organizes cables (9), and feeding equipment (1021), the UGV feeder (8). It is illustrated that the UPV with conveyor belt (1D) is harvesting with robot arms (1.2) to crop (613), which are transferred to the conveyor belt (1.19), which are selected by the UGV distributor (12) and by belt transporter (12.6) are transferred to the UGV loader (13), which form a transport and production line, while in flight, the UAV multitasking (10) harvests crops at altitude and deposits them in the UGV loader (13) or well in container (12.2) of the UGV distributor (12). Illustrated is the conveyor belt (12.6) of the UGV distributor (12), in inclined position “A” and horizontal position “B”, and the container (12.2) of the UGV loader (13), in inclined position “A” and in horizontal position “B”. It is also illustrated that the UGV distributor (12) and the UGV loader (13) have independent extendable legs (12.4) to adjust their height for terrain and for the level of work on the transportation and production line.

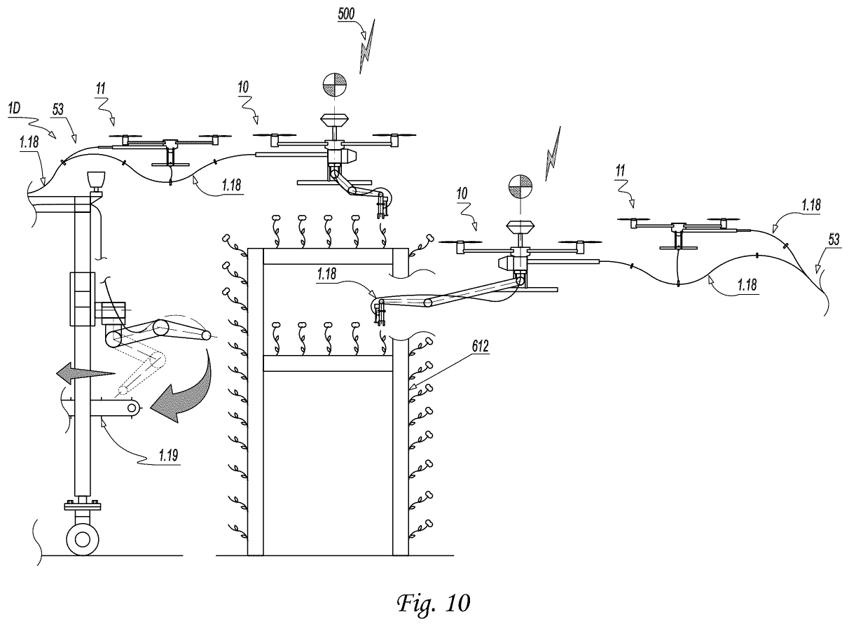

FIG. 10: in continuation to FIG. 9, the operational capacity of the vehicles in flight is illustrated, the UAV multitasking (10) enters a grabber at the end of its robot arm into a confined space of a vertical cultivation structure (612), while the UAV organizes cables (11) to avoid entanglement of the power cables, simultaneously the robot arms (1.2) of the UPV with conveyor belt (1D) perform tasks on the vertical crop (612).

FIG. 11: UPV (1E), configuration for maintenance and cleaning of floating solar panels. Autonomous UPV (1E) is supported by review equipment (1019) and the UAV reviewer (2). It is illustrated that the autonomous UPV (1E) is performing a task on the floating photovoltaic panel (605), it is cleaning, using a cleaner (32) that is connected to the robot arm (1.2), where the portal rail legs (1.5) move through the technical corridors of the floating structure (606). It is illustrated that the portal rail legs (1.5), which are independent, react to the movements of the sea environment, allowing stability to perform the task on the construction site. It is illustrated that the UAV reviewer (2) provides information on the construction site, the environment and the task, on the surface being cleaned.

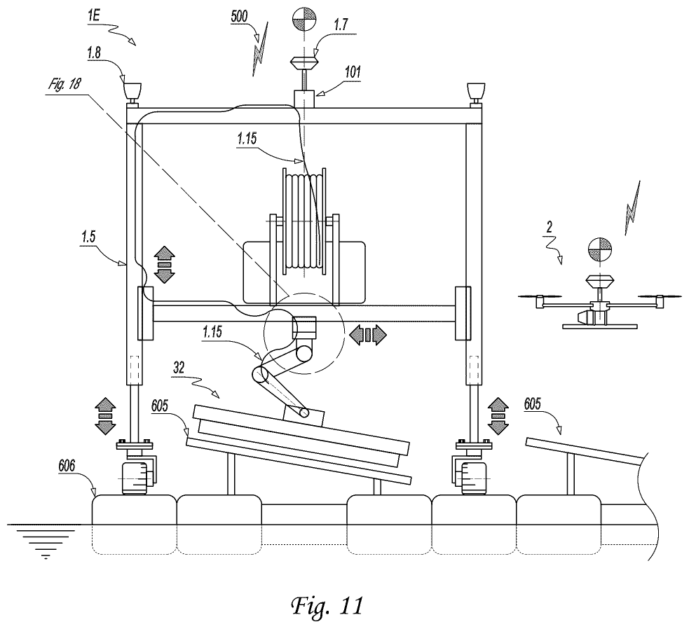

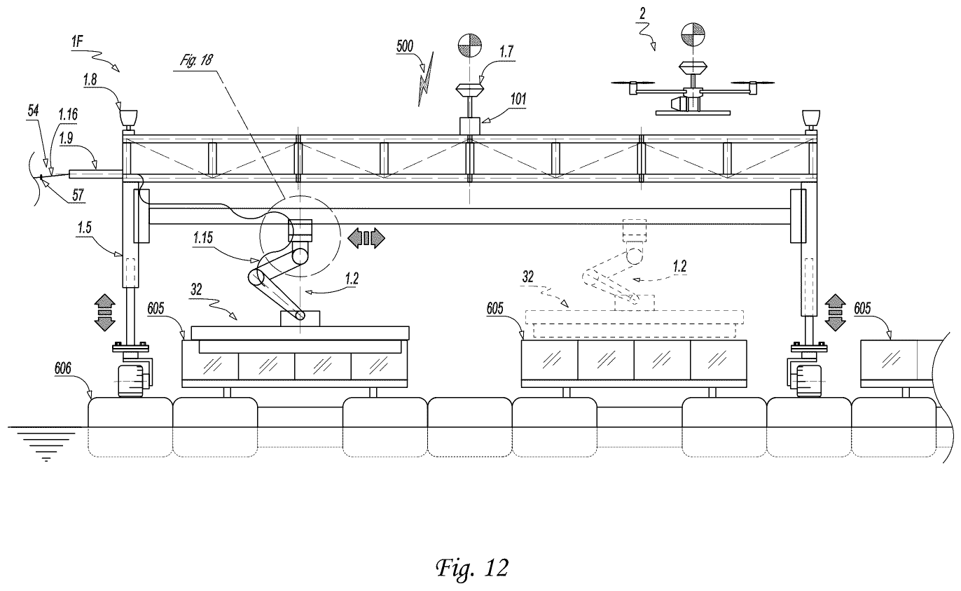

FIG. 12: UPV larger span and wiring (1F), configuration for maintenance and cleaning of floating solar panels. UPV larger span and wiring (1F) is supported by review equipment (1019) and the UAV reviewer (2). It is illustrated that the UPV larger span and wiring (1F), as in FIG. 11, is cleaning the floating photovoltaic panel (605), however, it is supported on the first and third technical corridors of the floating structure (606), allowing greater work coverage, more units to work and less travel. While the cable (1.16) that enters from the side, has encapsulated sensors along the sea cable (57).

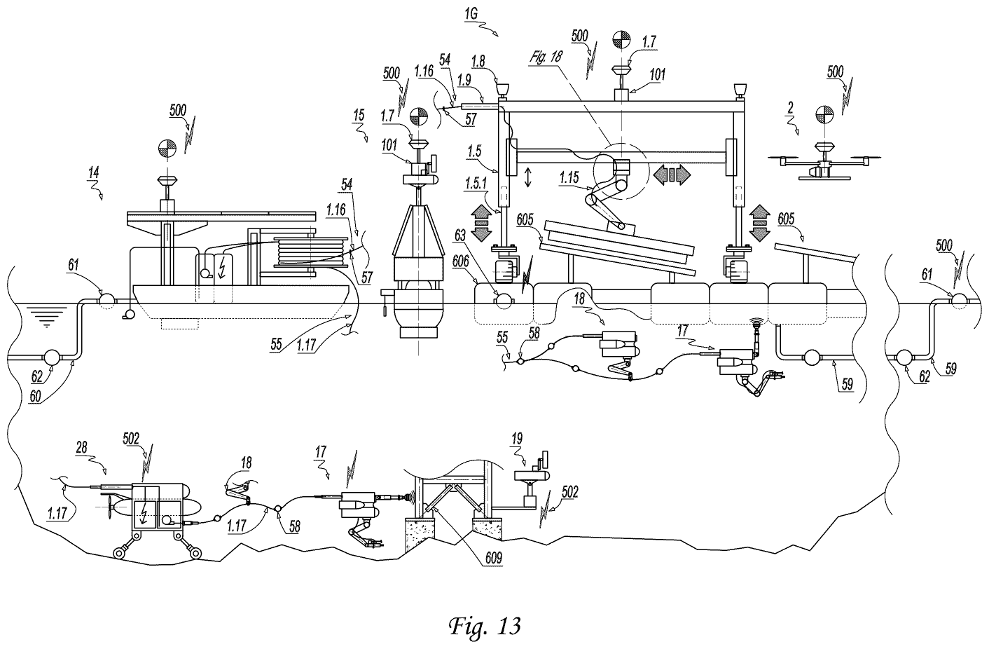

FIG. 13: UPV wired (1G), configuration for maintenance and cleaning of floating solar panels and on the sea surface and on the seabed: maintenance, inspection and monitoring equipment with load feeding method, energy power and feeding of additive fluids and/or wired subtractive. It is supported by: main multitasking equipment (1017), UUV wired multitasking (17), review equipment (1019), UAV reviewer (2), support equipment (1020), UUV organizes cables (18), feeding equipment (1021), the USV feeder (14), the USV self-stabilized buoy (15), the monitoring station (19) and the UUV feeder (28). It is illustrated, on the sea surface, that the UPV wired (1G) is cleaning the floating photovoltaic panel (605), and is powered by the USV feeder (14). The UUV wired multitasking (17) is attached to the floating structure (606) and performing a task, which is powered by the USV feeder (14), where the intelligent underwater wiring (55) is being managed by the UUV organizes cables (18). It is illustrated, on the seabed, that the UUV wired multitasking (17) is attached to an underwater structure (609) and performing a task, which is fed by the UUV feeder (28), where the intelligent underwater wiring (55) is being handled by the UUV organizes cables (18). The monitoring station (19) is connected to the underwater structure (609).

It is illustrated that the floating structure (606) is connected by sea conduit to the inverter station and along its length there are sensors encapsulated (59) on the underwater conduit (62). There are a series of sensors encapsulated in the floating construction site (63) and also the sea conduit from USV inland feeder to feeding station (60) has a series of sensors encapsulated on the underwater conduit (62), while sensors encapsulated (61) on the sea conduit on the surface. Also the vehicles on the underwater bottom have sensors encapsulated (58) along the underwater smart wiring (55). These encapsulated sensors, submerged, floating and on the construction site, allow reading of parameters of the construction and wiring above sea and undersea: position, speed, acceleration, rotation, etc. Along with the reading of parameters of the USV self-stabilized buoy (15), the monitoring station (19) and the UAV reviewer (2), a 3D survey is carried out on the surface of the sea, under the sea and in flight, which allows maneuvers to be carried out. free of entanglement for the cables, and free the construction site and vehicles from accidents.

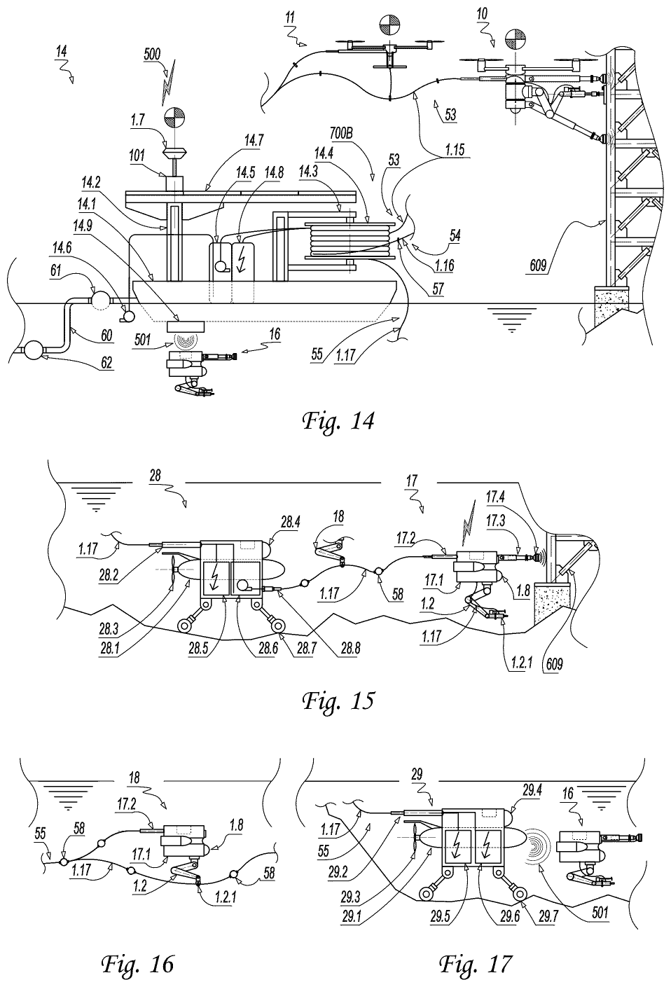

FIG. 14, in continuation of FIG. 13. Illustrated is the USV feeder (14) that feeds the vehicles in flight, the UAV multitasking (10) and the UAV organizes cables (11) and undersea the UUV autonomous multitasking (16) is charging wireless power using induction battery charger (14.9). The UAV multitasking (10) is attached and performing one of multiple possible tasks on an underwater structure (609) that is above sea level, while the UAV organizes cables (11) and frees the intelligent aerial wiring (53) from interference. The intelligent aerial wiring (53) comprises a cable (1.15) and along it a series of encapsulated sensors (not shown). The USV feeder (14) will have as many centralized mobile reel units (700B), according to the vehicles: on the surface of the sea, under the sea and in flight.

FIG. 15, in continuation to FIG. 13. Illustrated is the UUV feeder (28) that feeds the UUV wired multitasking (17) that performs one of multiple possible tasks to an underwater structure (609), while the UUV organizes cables (18) free underwater wiring from interference (1.17).

FIG. 16, in continuation of FIG. 13. Illustrated is the UUV organizes cables (18) that is powered and in turn manages the intelligent underwater wiring (55). This intelligent underwater wiring (55) includes the underwater wiring (1.17) and the series of sensors encapsulated (58) along it.

FIG. 17, in continuation of FIG. 13. The UUV feeder (29) that performs wireless charging on UUV autonomous multitasking (16) is illustrated. The UUV feeder (29) is being powered from the surface by underwater smart wiring (55).

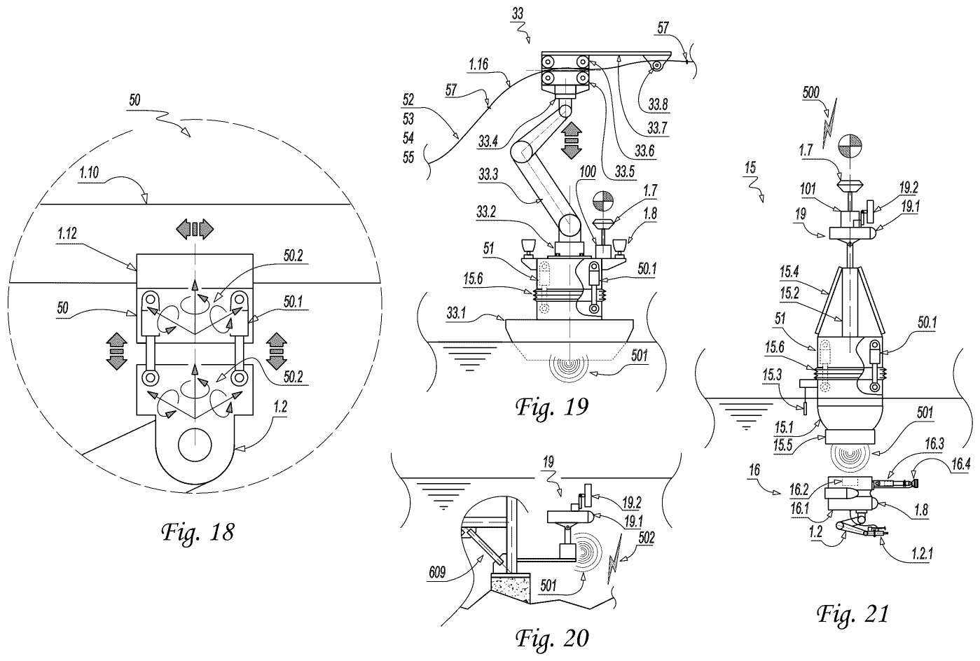

FIG. 18 is a detail of the stabilization base (50) for the robot arm (1.2) of the system. The horizontal rail (1.10) is illustrated, which on both sides has a vertical carriage (1.11), which runs on the portal rail leg (1.5). In turn, the horizontal rail (1.10) transits the horizontal carriage (1.12), from where the stabilization base (50) is connected, which is linked to the robot arm (1.2), leaving a space between them in such a way that they absorb the differences in movements and acceleration of the vehicle in relation to the task being performed. The IMUs (50.2) are arranged in both the stabilization base (50) and the first body of the robot arm (1.2). The link is made with three linear actuators (50.1) distributed radially. If the vehicle is on sloping terrain or an object that is above the sea, and differences in level, position and acceleration occur, the artificial vision unit (1.8) and the multiplicity of sensors provide parameters with which the Software (1008) evaluates and the control unit (100 and 101) operates the actuators (50.1), allowing the robot arm (1.2) to be absorbed and stabilized.

FIG. 19, in continuation of FIG. 13. Illustrated is the USV organizes cables (33), which is a vehicle that acts on the sea surface, which supports cables that go from a feeder vehicle to a vehicle that executes a task: under the sea, on the sea surface, on land, or at a height above sea level. The sea stabilization base (51) allows stabilizing the range, orientation, and height maneuvers of the intelligent wiring (52, 53, 54, 55) aerial, sea and/or underwater, which manages the pusher (33.5 and 33.6) together with the robot arm (33.3). Also illustrated is the power-charging induction link (501) for charging other vehicles.

FIG. 20, in continuation of FIG. 13. The monitoring station (19) is illustrated, which is under the sea, connected to the underwater structure (609), which allows reading a multiplicity of parameters in the environment, the construction site, the tasks to be performed and vehicles. Also illustrated is the power-charging induction link (501) for charging other vehicles.

FIG. 21, in continuation of FIG. 13. The USV self-stabilized buoy (15) is illustrated, which is on the sea surface, which allows reading of multiple parameters in the environment, the construction site, the tasks to be performed and the vehicles. Recharging to an UUV autonomous multitasking (16) is illustrated, through an induction link charging energy power (501) to charge other vehicles.

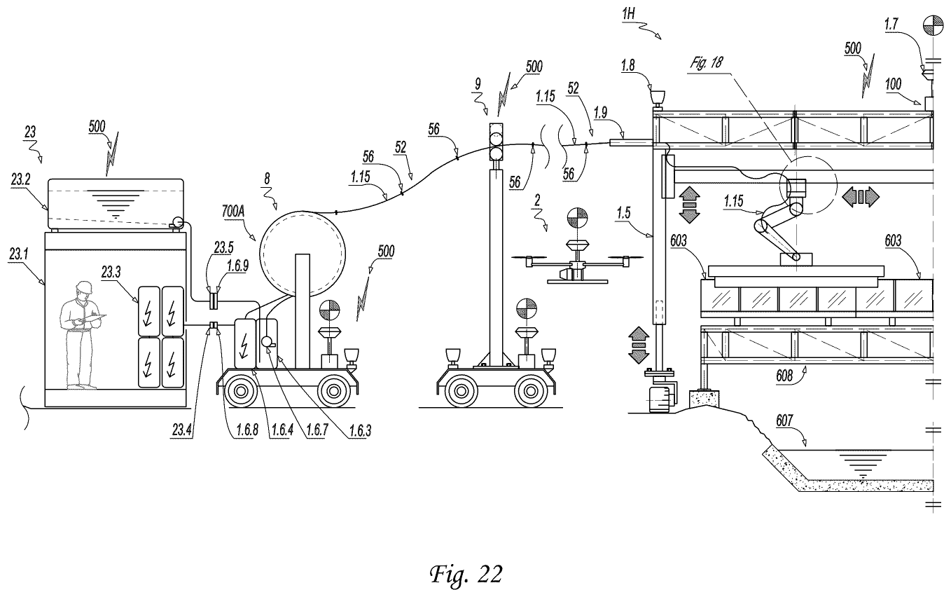

FIG. 22: UPV larger span and wiring (1H) for solar panels covers channels and highways, is supported by: review equipment (1019), the UAV reviewer (2), support equipment (1020), the UGV organizes cables (9), feeding equipment (1021), the UGV feeder (8) and equipment (1027), the transportable supply unit (23). The wired feeding method is illustrated, where the UPV larger span and wiring (1H) is being fed by the UGV feeder (8), while the UGV organizes cables (9), frees the intelligent terrestrial wiring (52) from interference, and the UAV reviewer (2) provides relevant information about the construction site, the vehicles, the environment, and relevant points of view for the maneuvers and tasks. The portal rail leg (1.5), by means of a parallel extendable portal legs (1.5.1), extends or retracts according to the terrain or the infrastructure of the construction site through which it passes, while the robot arm (1.2) moves along the rail. It is illustrated that the transportable supply unit (23), with a greater capacity of supplies, additive and/or subtractive fluids and charging power, feeds the UGV feeder (8). The UGV organizes cables (9) can be supported or replaced by UGV organizes cables (9A).

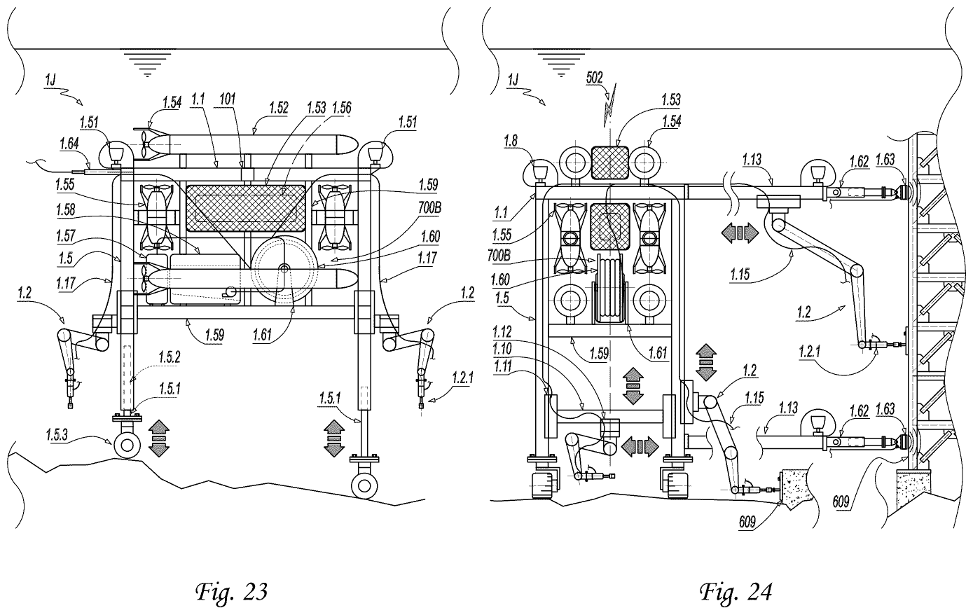

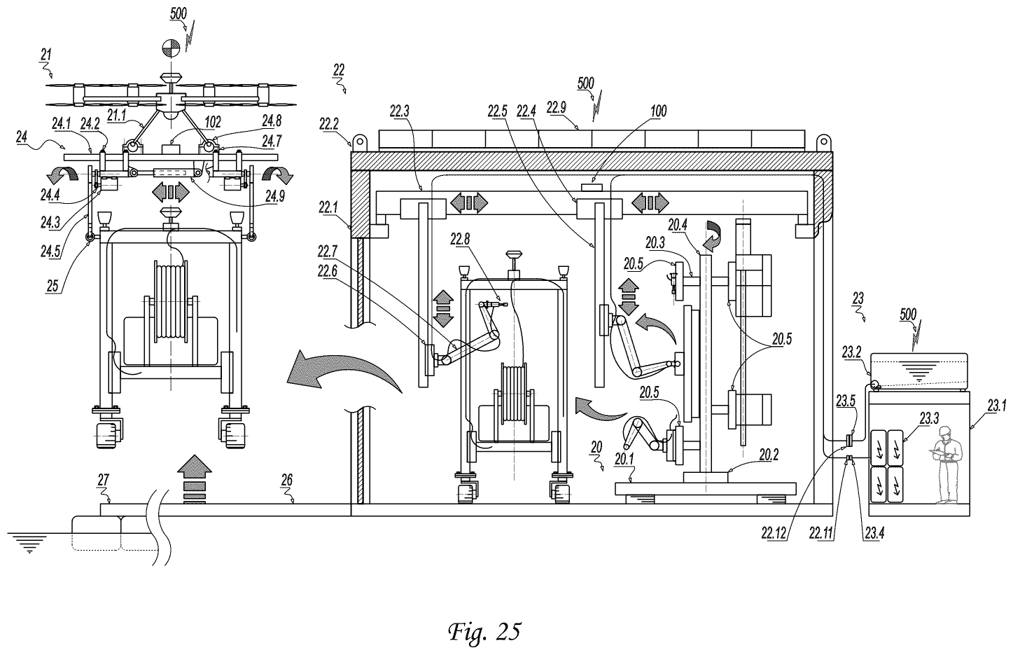

FIGS. 23 and 24: the UPV underwater (1J) is on the seabed performing a task on underwater structure (609). Illustrated is a pair of robot arms (1.62) for attachment to the underwater structure (609) and a pair of robot arms (1.2) that perform tasks. The portal rail legs (1.5), using parallel extendable portal legs (1.5.1), extend or retract according to the seabed.

FIG. 25: shows the assembly process of a vehicle in the transportable assembly unit (22) and which is then transported by the UAV transport (21), while the transportable assembly unit (22) is fed by the supply unit transportable (23). It is illustrated that the transportable assembly unit (22) has a crane bridge (22.3) that together with the robot arms (1.2) performs tasks on a vehicle, and the UGV tool holder (20) that holds the series of equipment and devices that They connect to the vehicle. After assembly, the UAV transport (21) lifts the vehicle, using the motorized lifting yoke (24), from the infrastructure; takeoff platform (26) or floating takeoff platform (27).

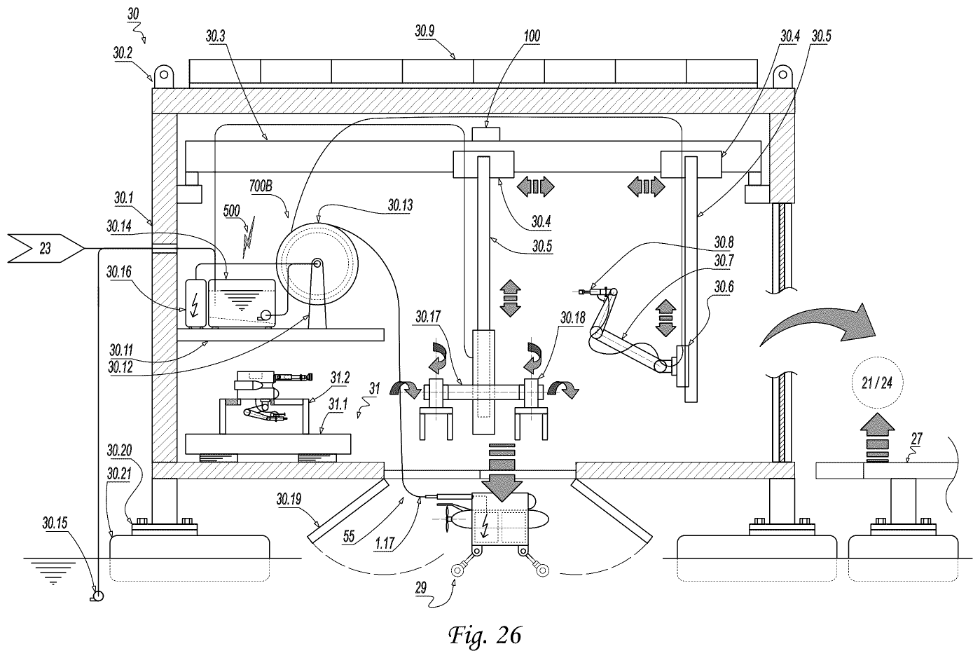

FIG. 26: shows the maintenance and submersion process under water, of a vehicle from the transportable assembly unit over water (30), by air and feeding supplies to the vehicle. It is illustrated that the transportable assembly unit over water (30) has inside it: UGV vehicle carriers (31), an overhead crane (30.3) where a robot arm (30.7) and a rail and clamp-type end effector (30.18) travel a supply unit and the centralized mobile reel unit (700B). Then, a vehicle is supported on a UGV vehicle carriers (31) where the robot arms (30.7) will adjust it and a rail and clamp-type effector (30.18) will lift it to move it through a motorized gate (30.19) until it is submerged, and said vehicle is wired, through the intelligent underwater wiring (55) delivered by the centralized mobile reel unit (700B). It is illustrated that the transportable supply unit (23) allows feeding the supply unit and the mobile reel centralized unit (700B). It is illustrated that the transportable assembly unit over water (30) also allows a delivery of a vehicle through a side gate to the floating takeoff platform (27), so that connected the UAV transport (21) with motorized lifting yoke (24), lift and transport it to a defined destination.

### System Methods.

A method is disclosed for the arrangement of the system (1000) on land construction site, on the water surface and under water, because it includes the following steps, regardless of the order:
a) monitor and supervise the operation through at least one UAV that travels through the deployment area by air;
b) monitor and supervise the operation through at least one USV that travels through the deployment area over water;
c) monitor and supervise the operation through at least one UUV that travels through the deployment area under water;
d) transport and arrange operating vehicles on land, on and under water (1014);
e) move, arrange and install supplies (1015);
f) move, arrange and install transportation and storage (1016).
g) steps a, b and c, regardless of the order, likewise;
h) steps d, e and f, regardless of the order.

A method is also disclosed for installing the transportable assembly unit (22), the transportable supply unit (23) and the takeoff platform (26) of the system (1000) on land construction site, because it includes the following steps:
a) monitor and supervise the operation through at least one UAV that travels through the deployment area;
b) moving the transportable assembly unit (22), the transportable supply unit (23) and the takeoff platform (26);
c) clean and level the surface;
d) relocate, align, and;
e) ensure technical corridor and supply connections.

A method is also disclosed for installing the transportable assembly unit (22), the transportable supply unit (23) and the floating takeoff platform (27) of the system (1000) on water construction site, because it includes the following steps:
a) monitor and supervise the operation through at least one UAV, a USV and a UUV that travels through the deployment area;
b) transport USV transportable assembly unit (22), the transportable supply unit (23) and floating takeoff platform (27);
c) anchor to a larger structure or to the shore and/or bottom using cables and concrete blocks, and;
d) ensure technical corridor and supply connections.

A method is also disclosed for installing the transportable assembly unit over water (30) of the system (1000) on water construction site because it includes the following steps:
a) monitor and supervise the operation through at least one UAV that travels through the deployment area;
b) moving the transportable assembly unit over water (30), the transportable supply unit (23) and the floating takeoff platform (27);
b) anchor to a larger structure or to the shore and/or bottom using cables and concrete blocks, and;
c) ensure technical corridor and supply connections.

A method is also disclosed for moving at least one vehicle, equipment or device by a UAV, using a UAV transport (21) and motorized lifting yoke (24) of the system (1000), because it includes the following operations:
a) monitor and supervise the operation through at least one UAV that travels through the deployment area;
b) attach a motorized lifting yoke (24) to a UAV transport (21) and put into flight;
c) bring the UAV pair (21 and 24) closer to at least one vehicle, equipment or device;
d) at least one vehicle, equipment or device engage a suitable portion of the UAV pair (21 and 24);
e) stabilize according to the center of gravity;
f) lift from and transfer to, and descend to a suitable area.

A method is also disclosed for transporting the transportable assembly unit (22) and the transportable assembly unit over water (30) by air, because it includes the following operations:
a) secure and fix the interior equipment;
b) monitor and supervise the operation through at least one UAV that travels through the deployment area;
c) hook the lifting means, lifting ear (22.2) to the capable aerial vehicle;
d) stabilize according to the center of gravity;
e) lifting from, transferring and lowering to a clear area over land or water, as appropriate.

A method is also disclosed of assembling at least one vehicle, equipment or system device (1000) by the transportable assembly unit (22), because it includes the following operations:
a) choose a component from the UGV tool holder (20), using the robot arm (22.7);
b) move the components to be assembled to an assembly area;
c) assemble the components using the robot arm (22.7), and;
d) inspect and review the assembly, at least by a LIDAR system.

A method is also disclosed of immersion of at least one vehicle, equipment or device of the system (1000) from the transportable assembly unit over water (30), because it includes the following operations:
a) after assembly, inspection and assembly;
b) lift using a rail and clamp-type end effector (30.18);
c) transfer over and equidistant to the motorized gate (30.19);
d) read and ensure that the environment where the immersion is made is stable;
e) open motorized gate (30.19);
f) perform descent using a rail and clamp-type end effector (30.18);
g) establish communication and delivery of subsea cable (1.17) as it descends;
h) read and enable immersion protocol and vehicle operation.

A method is also disclosed of supplying at least one vehicle by the transportable supply unit (23) of the system (1000), because it includes the following operations:
a) verify the subtractive additive fluid tank (23.2) at a higher height than the vehicle to be loaded;
b) establish communication with sensors in easy contact (23.5) for additive and subtractive fluids;
c) establish communication with easy contact sensors (23.4) for energy charging power;
d) bring the vehicle, equipment or unit to be loaded closer to the easy contacts (23.4) and (23.5);
e) stop vehicle and activate power.

A method is also disclosed of continuous supply of at least one vehicle in flight of the UAV multitasking (10) and the UAV organizes cables (11) dependent on the UPV with conveyor belt (1D) on the ground and the USV feeder (14) on the sea surface, of the system (1000), because it includes the following operations:
a) establish communication between the UPV, USV, UAV and the mobile reel centralized unit (700A or 700B);
b) activate the operation protocol to be carried out (task) and activate the supply of intelligent aerial wiring (53) through a reel (1.6.2 and 14.4) according to the movement of the UAVs in flight, and;
c) activate the feeding protocol for supplies in the tank of additive and/or subtractive fluids (1.6.3 and 14.5) and series of batteries (1.6.4 and 14.8) according to operational tools in UAVs (10 and 11) in flight.

Those skilled in the art will understand that the above refers only to a preferred embodiment of the present disclosure, whose description focuses on the core of the system, methods and devices, for which there are a series of details not shown and certainly omitted that the mechanical technique, aeronautics, nautical, robotics, hydraulics, pneumatics, electricity, electronics and computing, allows today without much effort to achieve, are normal engineering problems that are well known to experts in the field, and will not be explained in more detail in this document.

Those skilled in the art will further understand that the foregoing refers only to a preferred embodiment of the present disclosure, which is susceptible to modifications without implying a departure from the scope of the present disclosure, defined by the claims that follow.

1. A system (1000) to carry out a multiplicity of possible tasks in construction site located on: land, air, over water and under water, through infrastructure, vehicles, equipment and devices, which can be operated autonomously, semi-autonomously or by remote control, where the vehicles can operate independently or collaboratively, where any of the vehicles is complemented by others in the system partially or completely, CHARACTERIZED because it includes at least:
a) a control base (1001) that in communication with a control unit (100, 101 and/or 102) for the operation of the system (1000) to control in isolation or jointly, on land, in the air, on the sea surface and under sea, the equipment: operation (1014), supplies (1015) and transportation and storage (1016); where the operation equipment (1014) includes: main multitasking equipment (1017), secondary multitasking equipment (1018), review equipment (1019), support equipment (1020), feeding equipment (1021), robotic arm (1022), fixation effector (1023), end effector (1024) and device (1025); where supply equipment (1015) includes: supplies (1026) and equipment (1027); where the transportation and storage equipment (1016) includes: transfer equipment (1028), configuration equipment (1029) and infrastructure (1030); where the main multitasking equipment (1017) comprises at least: some UPVs Portal-type multi-task autonomous unmanned vehicle (1, 1A to 1J), a UAV multitasking (10) and an UUV autonomous multitasking (16 and 17); where the secondary multitasking equipment (1018) comprises at least: a UGV manipulator (4), an UGV loader (5), an UGV distributor (12) and an UGV loader (13); where the review teams (1019) comprise at least: an UAV reviewer (2), an UGV reviewer (3), an USV self-stabilized buoy (15) and an UUV autonomous multitasking (16); where the support equipment (1020) comprises at least: an UAV organizes cables (11), some UGV organizes cables (9 and 9A), an UUV organizes cables (18), an UGV tool holder (20), an UGV vehicle carriers (31) and a USV organizes cables (33); where the feeding equipment (1021) comprises at least: some UGVs wireless feeder (6 to 8), an USV feeder (14), some UUVs feeder (28 and 29), a monitoring station (19) and some mobile reel centralized units (700A and 700B); where the robotic arms (1022) comprise at least one robot arm (1.2, 1.62, 16.3 and 17.3); where the fixing effectors (1023) comprise a multiplicity of grabbers, such as: suction cup type, magnetic, etc.; where the devices (1025) comprise at least: a pile presser (1.14), a conveyor belt (1.19), a motorized lifting yoke (24), a lifting ear (25), a cleaner (32), some sensors encapsulated (56, 57, 58, 61, 62 and 63) in cables and on construction site, etc.; where the supplies (1026) comprise a multiplicity of additive and subtractive fluids, and energy-power charges, such as: liquid solutions, gaseous compounds, water suction, alternating and direct electrical power, etc.; where the equipment (1027) comprises a transportable supply unit (23); where the transfer equipment (1028) comprises a UAV transport (21); where the configuration equipment (1029) comprises at least one transportable assembly unit (22) and one transportable assembly unit over water (30); where the infrastructure (1030) comprises at least one takeoff platform (26) and a floating takeoff platform (27);
b) UPVs Portal-type multi-task autonomous unmanned vehicle (1, 1A to 1J), which include a modular portal-type structure (1.1) where equipment and other devices are assembled according to the environment where the task is located (ground, air, on the surface water and under water), at least three portal rail legs (1.5), each including two parallel extendable portal legs (1.5.1), to adapt to the inclinations of the terrain and overcome obstacles, on these portal rail legs (1.5) are they move motorized, horizontal rail (1.10), to provide work coverage to at least one robot arm (1.2), with several degrees of freedom specially configured with functional and operational tools to execute at least one specific assigned and predefined task, of multiple possible tasks on a construction site, and at least one other robot arm (1.62) on a cantilever rail (1.13) to attach to a structure on the construction site and/or the environment, to allow precision and stability;
c) the UPV vehicle (1) which additionally includes at least: a mobile reel centralized unit (700A), reel (1.6.2), a tank of additive and/or subtractive fluids (1.6.3) and a series of batteries (1.6.4);
the UPV (1C) which additionally includes at least: a pile presser (1.14);
the UPV with conveyor belt (1D) that additionally includes at least: a conveyor belt (1.19), an UAV multitasking (10), and an UAV organizes cables (11);
d) the UPV underwater (1J) which additionally includes at least: a mobile reel centralized unit (700B), a foam flotation module (1.53), a series of propellers (1.54 and 1.55) and a series of batteries (1.56);
e) the UUV wired multitasking (17) (UUV, which means “Autonomous Underwater Vehicle”), which has at least one robot arm (1.2) to execute at least one task in a work and a robot arm (17.3) to attach to a structure of the work, to allow precision and stability;
f) for operation on the ground and in flight, the system (1000), comprises at least one UPV (1), where the UAV reviewer (2) in the air and the UGV reviewer (3) on the ground (UGV, which means “Unmanned Ground Vehicle”), are configured to supervise and inspect tasks executed by UPVs (1, 1A, 1B, 1C, 1D and 1H) and UAVs multitasking (10), to sense and scan the location of said task; where the UGV feeder (8) and the mobile reel centralized unit (700A) are configured to supply or extract fluids through cables, hoses or supply ducts to the effectors of the robot arm (1.2); where the UGVs (4, 5, 12 and 13) and UAVs multitasking (10) are configured to support the execution of tasks; where the UGV organize cables (9 and 9A) and UAV organize cables (11) are configured to keep the cables and hoses suspended in the air, while;
g) for operation on the sea surface and in flight, the system (1000), comprises at least the autonomous UPV (1E), where the USV self-stabilized buoy (15) (USV, which means “Unmanned Surface Vehicle”) on the sea surface and the UAV reviewer (2) in the air, are configured to supervise and inspect tasks executed by UPVs (1E, 1F, 1G and 1H) and UAV multitasking (10), to sense and scan the location of said task; wherein the USV feeder (14) and the mobile reel centralized unit (700B) are configured to supply or extract fluids through cables, hoses or supply ducts to the effectors of the robot arm (1.2); where the USV self-stabilized buoy (15) and UAV multitasking (10) are configured to support the execution of tasks; where USV organizes cables (33) and UAV organizes cables (11) are configured to keep the cables and hoses suspended in the air, while;
h) for underwater operation, the system (1000), comprises at least the UPV underwater (1J), where the UUV autonomous multitasking (16) is configured to supervise and inspect tasks executed by UPV underwater (1J) and UUV wired multitasking (17), to sense and scan the location of said task; where the USV feeder (14), UUV feeder (28) and the mobile reel centralized unit (700B) are configured to supply or extract fluids through cables, hoses or supply ducts to the effectors of the robot arm (1.2); where the USV self-stabilized buoy (15), UUV wired multitasking (17), UUV feeder (29) and monitoring station (19), are configured to support the execution of tasks; where UUV organizes cables (18) is configured to keep cables and hoses free of interference;
i) wherein the UGV reviewer (3), comprises at least: a drive system where it extends on a pedestal (3.2) that is adjusted in height by means of a linear actuator (3.3) to which a rotation unit (3.4) is connected and from this, a vision unit;
j) wherein the UGV loader (5) comprises at least: a driving means where locates a robot arm (1.2) with an end effector and a guide for the cable from the mobile reel centralized unit (700A), in addition to, a container with means to detect and contain the load, and means to tilt and rotate said container;
k) wherein the UGV wireless feeder (6) comprises at least: location means, vision and control, and an induction battery (1.6.6);
l) wherein the UGV feeder (7) comprises at least: location means, vision and control, a tank for additive and/or subtractive fluids (1.6.3), a series of batteries (1.6.4), an induction battery charger (1.6.5) and an easy contact (1.6.9) for fluids additives and/or subtractive;
m) wherein the UGV feeder (8) comprises at least: location means, vision and control, a tank for additive and/or subtractive fluids (1.6.3), a series of batteries (1.6.4), an object dispensing warehouse, and a mobile reel centralized unit (700A);
n) wherein the UGV organizes cables (9A), comprising at least: a type spider system drive, a robot arm (9A.3) at the end of which an articulated cable pusher (9A.5 and 9A.6) is connected and some guides, which open like a grabber, through which the cable passes of the system (1000), the one who lifts, moves, pushes, pulls, lets pass and brakes;
o) wherein the UGV distributor (12) comprises at least: a container (12.2) with a vibrating base, robot arm (1.2), extendable legs (12.4), a conveyor belt (12.6), which, by means of linear actuators and rotation units, tilts said conveyor belt, and tilts and rotates said container;
p) wherein the USV feeder (14), which comprises a pontoon-type boat (14.1) and because it includes at least: means of location, artificial vision and control, on the surface, a deposit of additive and/or subtractive fluids (14.5), a series of batteries (14.8), a mobile reel centralized unit (700B) that has of cables, hoses and ducts, and under the pontoon, inside an induction battery charger (14.9);
g) wherein the USV self-stabilized buoy (15) that comprises a hull (15.1) where projects a tower (15.2) and because it includes at least: at the upper end, means of location, artificial vision and control, some high-power LED spotlights (19.2), a laser pointer (not shown), while the helmet and The tower are separated by a sea stabilization base (51) that comprises three actuators (50.1) arranged radially, and where, the clearance that allows these to be brought closer and further away, perimeter to the hull, a multiplicity of sensors (15.3) are projected towards the seabed, and an induction battery charger (15.5) is located under the hull;
r) wherein the UUV autonomous multitasking (16), comprises an UUV (16.1) that includes the least: in the front an artificial vision unit (1.8), in the lower part a robot arm (1.2), and at its end, operational and functional tools, an end effector (1.2.1), while in the front and upper two robot arms (16.3), and each at its end, a fixation effector (16.4), while an induction battery (16.2) is located inside at the top;
s) wherein the UUV organizes cables (18) that comprises a body (17.1) because it includes the least: means of artificial vision, control and sonar electronics (not shown) and, in the lower part, a robot arm (1.2), and at its end an end effector (1.2.1) a grabber, which includes a pulley and a motorized pulley (not shown), which opens like a grabber, through which cable passes of the system (1000), which lifts, moves, pushes, pulls, lets pass and brakes;
t) wherein the monitoring station (19) because it includes at least: location means, sonar control and electronics (not shown) and a series of induction battery chargers (not shown), and also artificial vision means and a high-power LED spotlight (19.2), where each one is connected to a motorized base;
u) wherein the UUV feeder (28) that comprises a main hull (28.1), because it includes at least: control means, artificial vision and sonar electronics (not shown), a pair of thrusters (28.3), two lower pairs of front and rear wheels (28.7), a series of batteries (28.5), a tank of additive and/or subtractive fluids (28.6), and a mobile reel centralized unit (700B, not shown) that feeds through cables to the other vehicles in the environment;
v) wherein UUV feeder (29) that comprises a main hull (29.1), because it includes at least: control means, artificial vision and sonar electronics (not shown), a pair of thrusters (29.3), two lower pairs of front and rear wheels (29.7), a series of batteries (29.5), and a series of induction batteries (29.6) to power the other vehicles;
w) wherein the USV orders cables (33) that comprises an USV pontoon (33.1) and includes at least: control means, artificial vision and sonar electronics (not shown), a sea stabilization base (51) is located on the pontoon deck, comprising at least three radially distributed actuators, one actuator (50.1) and sensors (50.2), and that from the cover of the sea stabilization base (51) a base rotation unit (33.2) is connected, where a robot arm (33.3) is projected, and at its end an articulated pusher (33.5 and 33.6), which by means of an actuator, guides, spacer and rollers, which opens like a grabber, through which cable passes of the system (1000), which lifts, moves, pushes, pulls, lets pass and brakes;
x) wherein the motorized lifting yoke (24) to transport any component of the system, which includes at least, means to regulate the width of said components, motorized means to adjust and hook and means to attach to an UAV;
y) wherein the transportable supply unit (23) that includes at least: a series of energy charging batteries, a tank of additive and/or subtractive fluids (23.2), and connection terminals, to make delivery, contacts easy (23.4 and 23.5);
z) wherein transportable assembly unit (22) that includes at least: a crane bridge (22.3) where rails and carts transit to which a robot arm (22.7) is connected and its effector is fed by the transportable supply unit (23), and that together with an UGV tool holder (20) to execute one of multiple tasks on said components of the system;
aa) wherein the UGV tool holder (20) includes at least: a mobile platform (20.1), on which a rotation unit (20.2) is arranged, from which a carousel (20.4) is projected, to which a support (20.3) is arranged radially and which holds components, vehicle assemblies and tools for assembly;
ab) wherein transportable assembly unit over water (30) that includes: an UGV vehicle carriers (31), supply means and an overhead crane (30.3) where rails, cars and rotation units transit, where it is connected to at least one clamp-type end effector (30.18), to take and transfer these components, through a motorized gate, to the sea environment;
ac) wherein the UGV vehicle carriers (31) that comprises a mobile platform (31.1) because it includes at least: a series of batteries, an adjustable support (31.2) with motorized jaws that supports at least one component of the system;
ad) wherein the cleaner (32), which comprises a capable chamber and a cleaning roller (32.7) and: an air suction line, which extracts particles, a liquid spray line, to moisten and dilute difficult dirt, a pressurized air ejection line, to shake and release the dirt on the roller, a suction line for air plus liquid and a seal (32.8) that is perimeter of the entire assembly to suck and extract excess liquid plus dirty air;
ae) wherein the robot arm (1.2) comprises at its base a stabilization base (50) which comprises sensors (50.2) and an actuator (50.1), so that they respond and absorb the differences in height and speed of an irregular and rugged environment, while in its sea embodiment sea stabilization base (51), so that it responds to the heaves, pitches, balance and natural oscillations of the environment;
af) wherein the stabilization base (50 and 51) comprises an IMU (which means “Inertial Measurement Unit”);
ag) the control units (100, 101, 102) for the operation of the system (1000) are configured for flight maneuvers, navigation maneuvers, forward and lateral sonar emission, immersion, propulsion, communication, monitoring, operation of tasks and control; and
ah) a Wi Fi link, which allows data to be sent to the cloud and improve operations through artificial intelligence.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A system (100) to carry out a multiplicity of possible tasks on construction sites, according to claims No. 1, CHARACTERIZED because additionally for the operation of the system, the supplies of objects are carried out from an object dispenser (not shown), located next to mobile reel centralized units (700A and 700B) that include: one or several lines of conduit or hoses, grippers, jaws, a capsule plunger and rotation tables.

28. A system (100) to carry out a multiplicity of possible tasks on construction sites, according to claims No. 1, CHARACTERIZED because additionally for the operation of the system, the cables comprise a plurality of encapsulated sensors (56, 57, 58, 61, 62) on the wiring that are arranged along and on the construction site (63) configured to monitor its position, movement and emit signals to the control unit (100, 101, 102) and to the control base (1001).

29. (canceled)

30. (canceled)

31. (canceled)

32. A system (1000) to carry out a multiplicity of possible tasks on construction sites, according to claim No. 1, CHARACTERIZED because the robot arm (1.2) comprises at least one available tool, sensors and cameras.

33. (canceled)

34. (canceled)

35. A system (1000) to carry out a multiplicity of possible tasks on construction sites, according to claim No. 3, CHARACTERIZED because the sensor encapsulated in cables and on the construction site (56, 57, 58, 61, 62 and 63), comprise a sensor accelerometer gyroscope (50.2).

36. A system (1000) to carry out a multiplicity of possible tasks on construction sites, according to claim No. 1, CHARACTERIZED because the supply or extraction in: land, air, over water and under water, can be application of aqueous solution or air suction, from at least one nozzle (not shown).

37. A system (1000) to carry out a multiplicity of possible tasks on construction sites, according to claim No. 1, CHARACTERIZED because the UGV feeder (8) feeding the energy, charging power, to the other equipment, on the ground, through an electric cable.

38. A system (1000) to carry out a multiplicity of possible tasks on construction sites, according to claim No. 1, CHARACTERIZED because the transportable supply unit (23) feeding the energy, charges power, to the other vehicles and equipment, on the ground, through induction and magnetic easy contact.

39. A system (1000) to carry out a multiplicity of possible tasks on construction sites, according to claim No. 1, CHARACTERIZED because the UGV feeder (7) feeding the charging power to an UGV wireless feeder (6), and this in turn It distributes to other vehicles, on the ground, through induction and by easy magnetic contact.

40. A system (1000) to carry out a multiplicity of possible tasks on construction sites, according to claim No. 1, CHARACTERIZED because the USV feeder (14) feeding the energy, charges power to the other vehicles, equipment and devices, in flight, on land, over sea and under water, through electrical cables, by induction and by easy magnetic contact.

41. A system (1000) to carry out a multiplicity of possible tasks on construction sites, according to claim No. 1, CHARACTERIZED because the UUV feeder (28) feeding the energy, charges power to the other vehicles, equipment and devices, under water, through an electrical cable.

42. A system (1000) to carry out a multiplicity of possible tasks on construction sites, according to claim No. 1, CHARACTERIZED because the UUV feeder (29), the USV self-stabilized buoy (15), the USV organizes cables (33) and the monitoring station (19) feeding the charging energy to other vehicles and equipment, under water, through induction and by easy magnetic contact.

43. A system (1000) to carry out a multiplicity of possible tasks on construction sites, according to claim No. 1, CHARACTERIZED because at least one feeding vehicle to feed the energy, charging power, on land, on the water surface, in flight and under water, to the others vehicle and equipment, through a robot arm that relieves a battery that is on a carousel.

44. A system (1000) to carry out a multiplicity of possible tasks on construction sites, according to claim No. 1, CHARACTERIZED because the vehicles, equipment and devices, which receive additive and/or subtractive fluids and energy, charge power, through cables, hoses and ducts, on land and air land, are connected to the mobile reel centralized unit (700A) and the vehicles, equipment and devices, on surface water and under water, are connected to the mobile reel centralized unit (700B).

45. (canceled)

46. (canceled)

47. Method for the arrangement of the system (1000) according to claim No. 1 in a construction sites on land, over and under sea, CHARACTERIZED because it includes the following steps, regardless of the order:
a) monitor and supervise the operation through at least an UAV that travels through the deployment area by air;
b) monitor and supervise the operation through at least an USV that travels through the deployment area over water;
c) monitor and supervise the operation through at least an UUV that travels through the deployment area under water;
d) transport and arrange operating vehicles on land, over and under water (1014); that comprise at least: some UPVs Portal-type multi-task autonomous unmanned vehicle (1, 1A to 1J), an UAV multitasking (10) and an UUV autonomous multitasking (16 and 17), a UGV manipulator (4), a UGV loader (5), a UGV distributor (12) and a UGV loader (13), an UAV reviewer (2), an UGV reviewer (3), an USV self-stabilized buoy (15) and an UUV autonomous multitasking (16), an UAV organizes cables (11), some UGV organizes cables (9 and 9A), an UUV organizes cables (18), an UGV tool holder (20), an UGV vehicle carriers (31) and an USV organizes cables (33), some UGV wireless feeders (6 to 8), an USV feeder (14), some UUV feeder (28 and 29), a monitoring station (19), some mobile reel centralized units (700A and 700B), a robot arms (1.2, 1.62, 16.3 and 17.3); of a multiplicity of grabber, such as: suction cup type, magnetic, etc.; and a pile presser (1.14), a conveyor belt (1.19), a motorized lifting yoke (24), a lifting ear (25), a cleaner (32), and sensors encapsulated (56, 57, 58, 61, 62 and 63) in cables and in construction site;
e) move, arrange and install supplies (1015); that comprise a multiplicity of additive and subtractive fluids, and energy-power charges, such as: liquid solutions, gaseous compounds, water suction, AC and DC current, etc.; and a transportable supply unit (23);
f) move, arrange and install transportation and storage (1016); it comprises: an UAV transport (21), a transportable assembly unit (22), a transportable assembly unit over water (30), a takeoff platform (26) and a floating takeoff platform (27);
g) steps a, b and c, regardless of the order, likewise;
h) steps d, e and f, regardless of the order.

48. (canceled)

49. (canceled)

50. (canceled)

51. Method for transferring at least one vehicle, equipment or device by a UAV, using a UAV transport (21) and motorized lifting yoke (24) of the system (1000) according to claim No. 1, CHARACTERIZED because it includes the following steps:
a) monitor and supervise the operation through at least an UAV that travels through the deployment area;
b) attach a motorized lifting yoke (24) to an UAV transport (21) and put into flight;
c) bring the UAV pair (21 and 24) closer to at least a vehicle, equipment or device;
d) at least a vehicle, equipment or device engage a suitable portion of pair the UAV (21 and 24);
e) stabilize according to the center of gravity;
f) lift from and transfer to, and descend to a suitable area.

52. (canceled)

53. (canceled)

54. (canceled)

55. (canceled)

56. (canceled)
